(19) United States
(12) Patent Application Publication
(10) Pub. No.: US 2026/0109396 A1
(43) Pub. Date: Apr. 23, 2026

(54) VEHICLE STEERING APPARATUS AND VEHICLE INCLUDING THE SAME

(71) Applicant: HL MANDO CORPORATION, Gyeonggi-do (KR)

(72) Inventors: Hyunbi KWON, Gyeonggi-do (KR); Jaehoon BAE, Gyeonggi-do (KR); Kyoungmin KIM, Gyeonggi-do (KR); Deokman JI, Gyeonggi-do (KR)

(21) Appl. No.: 19/361,736

(22) Filed: Oct. 17, 2025

(30) Foreign Application Priority Data
Oct. 17, 2024 (KR) 10-2024-0142093
Oct. 17, 2024 (KR) 10-2024-0142096
Sep. 30, 2025 (KR) 10-2025-0142572

(51) Int. Cl. B62D 5/04; B62D 5/00

(52) U.S. Cl. CPC B62D 5/0448; B62D 5/003

(57) ABSTRACT

A vehicle steering apparatus and a vehicle include a ball nut rotatably coupled to a rack bar by means of a ball and configured to slide the rack bar in an axial direction by rotation of the ball nut, first and second nut pulleys provided on an outer surface of the ball nut, a first motor pulley provided on a first motor and operably connected to the first nut pulley through a first belt, a second motor pulley provided on a second motor and operably connected to the second nut pulley through a second belt, and an anti-rotation member supporting the rack housing and surrounding the rack bar and configured to prevent rotation of the rack bar.

### CROSS-REFERENCE TO RELATED APPLICATIONS

This application claims the priority to and the benefit of Korean Patent Application No. 10-2024-0142093 filed on Oct. 17, 2024, Korean Patent Application No. 10-2024-0142096 filed on Oct. 17, 2024, and Korean Patent Application No. 10-2025-0142572 filed on Sep. 30, 2025 in the Korean Intellectual Property Office, the disclosures of which are incorporated herein by reference in their entireties.

### BACKGROUND

### Field

The present disclosure generally relates to a vehicle steering apparatus and a vehicle including the same.

### Description of the Related Art

Power steering has been used in a steering apparatus for a vehicle to provide convenience in a driving operation by assisting an operating force applied to a steering wheel by a driver. The power steering includes hydraulic power steering using hydraulic pressure, electrohydraulic power steering using hydraulic pressure and power of a motor, and electric power steering using only power of a motor.

Recently, a steer-by-wire (SBW) steering apparatus has been developed. The steer-by-wire steering apparatus does not have a mechanical connection between the steering wheel and a road wheel such as a steering shaft, a universal joint, or a pinion shaft and includes an electric motor for steering the vehicle.

However, because the steer-by-wire steering apparatus does not have mechanical connection between the steering shaft and the road wheel, the driver's steering manipulation cannot be transmitted to the rack bar in the event of a failure of the motor, and the rack bar may be rotated by rotational torque of a ball nut, thereby degrading steering stability.

In addition, because there is no mechanical connection between the steering shaft and the road wheel, there is a need for a control technology to address a failure situation and precisely control motors associated with the steering wheel and the road wheel, respectively.

Therefore, there is a need for a technology to stably control the rack bar based on the driver's steering intention and perform a stable steering operation even though there is no mechanical connection between the steering shaft and the road wheel.

### SUMMARY

Some embodiments of the present disclosure may provide a vehicle steering apparatus and a vehicle including the same that can prevent rotation of a rack bar caused by rotational torque of a ball nut, thereby enhancing steering stability and allowing a driver's steering intention to be effectively and accurately transmitted to the rack bar.

According to certain embodiments of the present disclosure, a vehicle steering apparatus may include: a ball nut coupled to a rack bar by means of a ball and configured to slide the rack bar in an axial direction while rotating; first and second nut pulleys provided on an outer peripheral surface of the ball nut; a first motor pulley provided on a first motor and connected to the first nut pulley through a first belt; a second motor pulley provided on a second motor and connected to the second nut pulley through a second belt; and an anti-rotation member coupled to be supported on an outer peripheral surface of the rack bar and an inner peripheral surface of a rack housing and configured to prevent a rotation of the rack bar.

In addition, in an embodiment of the present disclosure, a support surface may be provided on the outer peripheral surface of the rack bar and formed as a flat surface formed by machining the outer peripheral surface of the rack bar in the axial direction, and the anti-rotation member may be supported on the support surface.

In addition, in an embodiment of the present disclosure, the anti-rotation member may include: a cylinder portion having an inner peripheral surface configured to support the outer peripheral surface of the rack bar, and an outer peripheral surface coupled to support the inner peripheral surface of the rack housing; and an inner peripheral support portion extending from the inner peripheral surface of the cylinder portion, formed as a flat surface facing the support surface, and supported on the support surface.

In addition, in an embodiment of the present disclosure, the inner peripheral support portion may be provided with an inner peripheral groove provided in the axial direction in an inner peripheral surface supported on the support surface.

In addition, in an embodiment of the present disclosure, the cylinder portion is provided with a one-end cut-out portion formed by cutting one end of the cylinder portion in the axial direction so that one end is open.

In addition, in an embodiment of the present disclosure, the one-end cut-out portion may be provided as two or more one-end cut-out portions spaced apart from one another in a circumferential direction of the cylinder portion.

In addition, in an embodiment of the present disclosure, the cylinder portion may be provided with the other-end cut-out portion formed by cutting the other end of the cylinder portion in the axial direction so that the other end is open.

In addition, in an embodiment of the present disclosure, the other-end cut-out portion may be provided as two or more other-end cut-out portions spaced apart from one another in the circumferential direction of the cylinder portion, and the other-end cut-out portions and the one-end cut-out portions may be disposed alternately.

In addition, in an embodiment of the present disclosure, the cylinder portion may be provided with a shaft hole configured to communicate with the other-end cut-out portion in the axial direction and connected to a position spaced apart from the inner peripheral surface of the inner peripheral support portion.

In addition, in an embodiment of the present disclosure, the anti-rotation member may further include an elastic member coupled to the outer peripheral surface of the cylinder portion and elastically supported on the inner peripheral surface of the rack housing.

In addition, in an embodiment of the present disclosure, a fixing protrusion may be provided on an outer peripheral surface of the inner peripheral support portion, protrude in a radial direction, and be coupled to a fixing groove of the rack housing.

In addition, in an embodiment of the present disclosure, a support groove may be recessed to a predetermined depth in the outer peripheral surface of the rack bar and elongated in the axial direction, and the anti-rotation member may be supported on the support groove.

In addition, in an embodiment of the present disclosure, the anti-rotation member may include: a cylinder portion having an inner peripheral surface configured to support the outer peripheral surface of the rack bar, and an outer peripheral surface coupled to support the inner peripheral surface of the rack housing; and an inner peripheral protruding portion protruding from the inner peripheral surface of the cylinder portion toward the support groove and inserted into and supported on the support groove.

In addition, in an embodiment of the present disclosure, the cylinder portion is provided with a one-end cut-out portion formed by cutting one end of the cylinder portion in the axial direction so that one end is open.

In addition, in an embodiment of the present disclosure, the one-end cut-out portion may be provided as two or more one-end cut-out portions spaced apart from one another in a circumferential direction of the cylinder portion.

In addition, in an embodiment of the present disclosure, the cylinder portion may be provided with the other-end cut-out portion formed by cutting the other end of the cylinder portion in the axial direction so that the other end is open.

In addition, in an embodiment of the present disclosure, the other-end cut-out portion may be provided as two or more other-end cut-out portions spaced apart from one another in the circumferential direction of the cylinder portion, and the other-end cut-out portions and the one-end cut-out portions may be disposed alternately.

In addition, in an embodiment of the present disclosure, the cylinder portion may be provided with a shaft hole configured to communicate with the other-end cut-out portion in the axial direction and connected to a position spaced apart from the inner peripheral surface of the inner peripheral protruding portion.

In addition, in an embodiment of the present disclosure, the anti-rotation member may further include an elastic member coupled to the outer peripheral surface of the cylinder portion and elastically supported on the inner peripheral surface of the rack housing.

In addition, in an embodiment of the present disclosure, the support surfaces may be respectively provided at positions facing each other in a radial direction of the rack bar, and the anti-rotation member may be supported on the support surfaces.

In addition, in an embodiment of the present disclosure, the anti-rotation member may include: a rotary member supported on the support surface and configured to rotate when the rack bar slides in the axial direction; and a rotation support member to which the rotary member is rotatably coupled.

In addition, in an embodiment of the present disclosure, a coupling groove may be provided in the inner peripheral surface of the rack housing, and the anti-rotation member may be coupled to and supported on the coupling groove.

In addition, according to some embodiments of the present disclosure, a vehicle may include: a ball nut coupled to a rack bar by means of a ball and configured to slide the rack bar in an axial direction while rotating; first and second nut pulleys provided on an outer peripheral surface of the ball nut; a first motor pulley provided on a first motor and connected to the first nut pulley through a first belt; a second motor pulley provided on a second motor and connected to the second nut pulley through a second belt; an anti-rotation member coupled to be supported on an outer peripheral surface of the rack bar and an inner peripheral surface of a rack housing and configured to prevent a rotation of the rack bar; a first motor sensor configured to detect a rotation position of a shaft of the first motor; a second motor sensor configured to detect a rotation position of a shaft of the second motor; and an electronic control device configured to use an electrical signal as an input value and control an output value to be transmitted to the first motor and the second motor.

According to some embodiments of the present disclosure, a vehicle steering apparatus and a vehicle including the same may prevent rotation of a rack bar caused by rotational torque of a ball nut, thereby enhancing steering stability and allowing the driver's steering intention to be effectively and accurately transmitted to the rack bar.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic view schematically illustrating a vehicle according to an embodiment of the present disclosure;

FIGS. 2 to 7 are partial views illustrating a vehicle steering apparatus according to an embodiment of the present disclosure;

FIG. 8 is a schematic view schematically illustrating a vehicle according to an embodiment of the present disclosure;

FIGS. 9 to 16 are partial views illustrating a vehicle steering apparatus according to an embodiment of the present disclosure;

FIG. 17 is a graph for explaining a method of estimating a rack bar position in accordance with a difference between first rotation information of a first motor and second rotation information of a second motor according to an embodiment of the present disclosure;

FIGS. 18 to 20 are partial perspective and exploded views illustrating a vehicle steering apparatus according to an embodiment of the present disclosure;

FIG. 21 is a cross-sectional view illustrating a vehicle steering apparatus according to an embodiment of the present disclosure;

FIGS. 22 and 23 are partial perspective and exploded views illustrating a vehicle steering apparatus according to an embodiment of the present disclosure;

FIG. 24 is a cross-sectional view illustrating a vehicle steering apparatus according to an embodiment of the present disclosure;

FIG. 25 is a partial perspective view illustrating a vehicle steering apparatus according to an embodiment of the present disclosure; and

FIG. 26 is a cross-sectional view illustrating a vehicle steering apparatus according to an embodiment of the present disclosure.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

When it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even when a relevant description is not specified. Further, the term “may” fully encompass all the meanings of the term “can”.

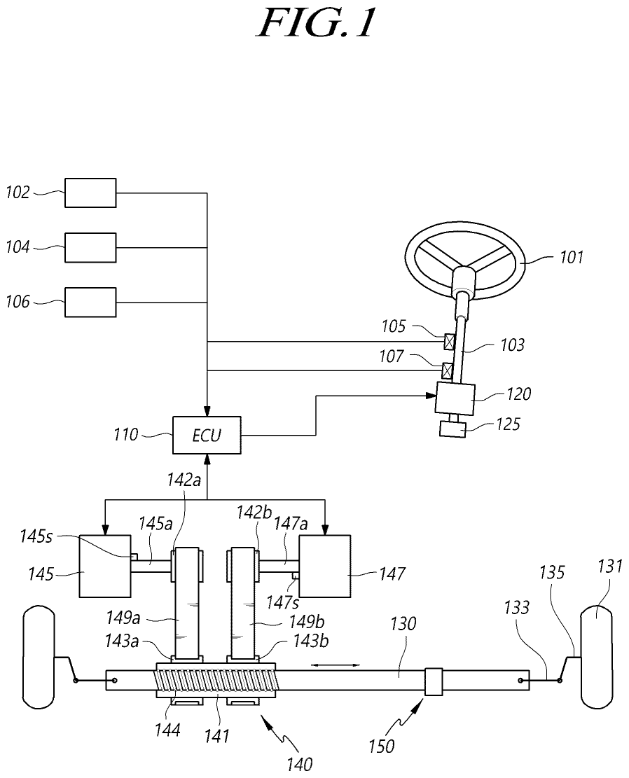

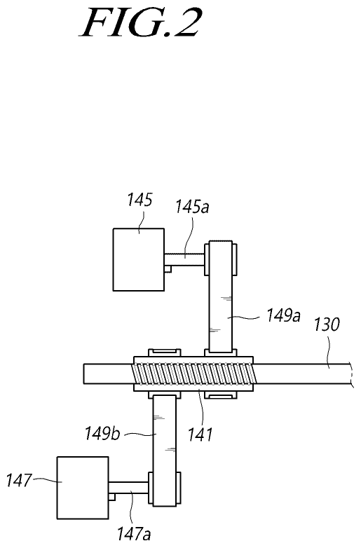

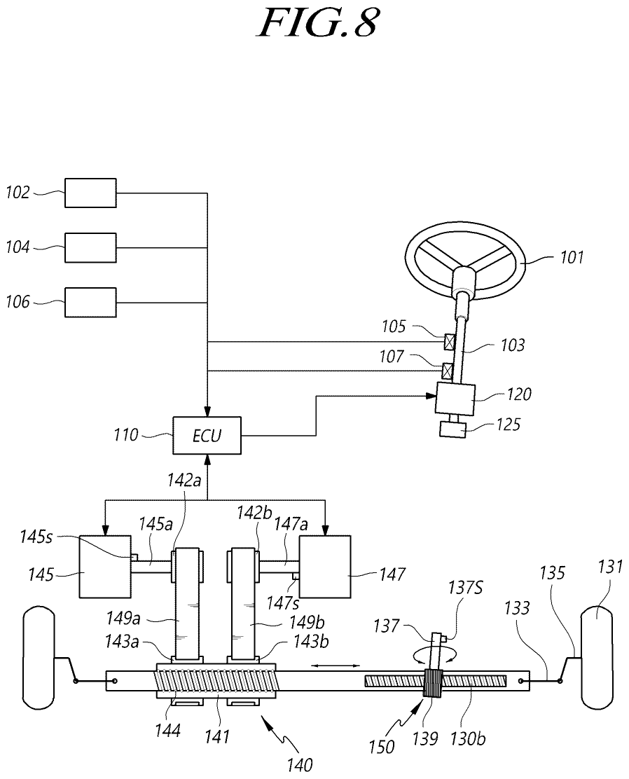

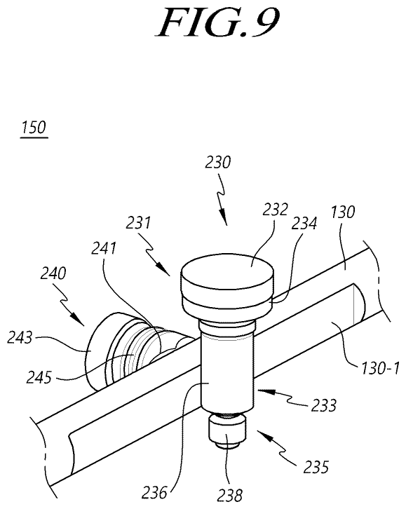

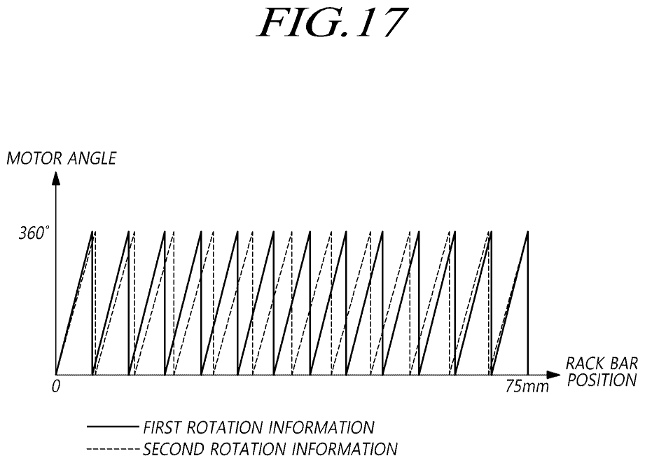

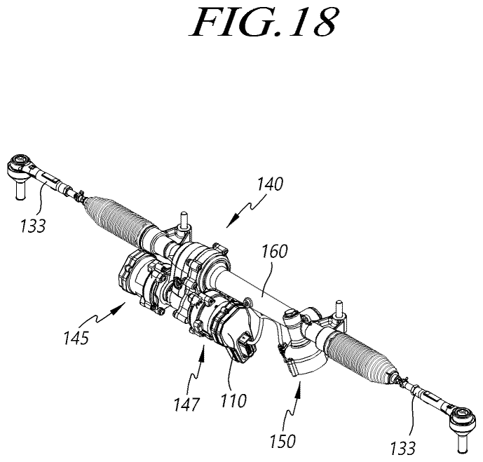

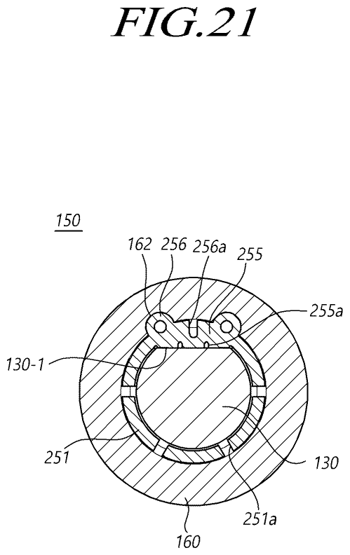

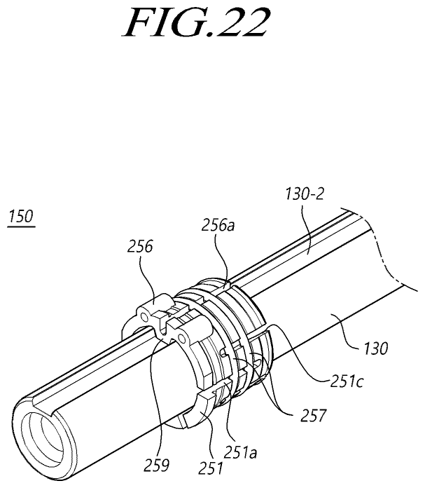

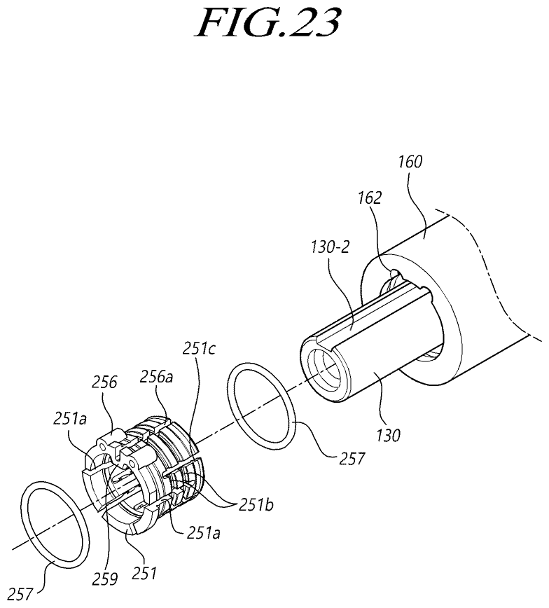

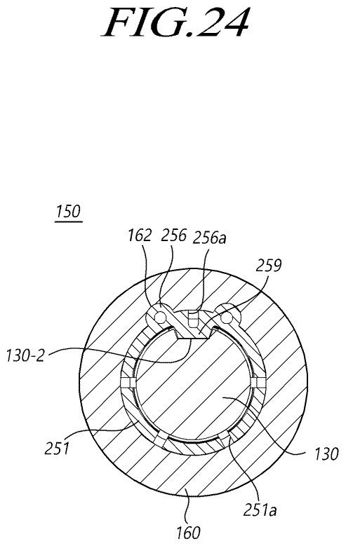

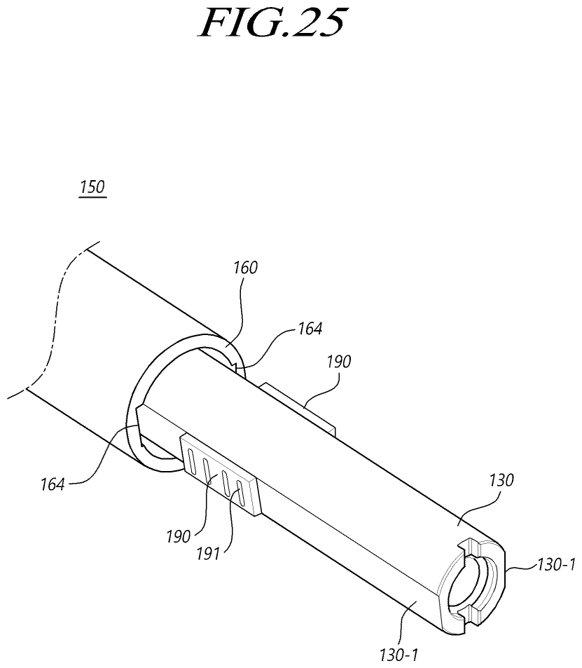

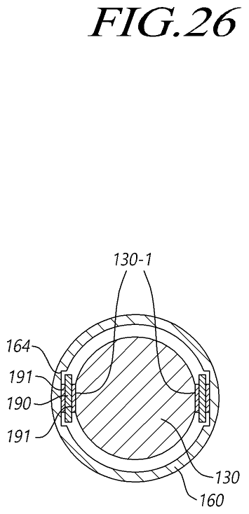

FIG. 1 is a schematic view schematically illustrating a vehicle according to an embodiment of the present disclosure, FIGS. 2 to 7 are partial views illustrating a vehicle steering apparatus according to an embodiment of the present disclosure, FIG. 8 is a schematic view schematically illustrating a vehicle according to an embodiment of the present disclosure, FIGS. 9 to 16 are partial views illustrating a vehicle steering apparatus according to an embodiment of the present disclosure, FIG. 17 is a graph for explaining a method of estimating a rack bar position in accordance with a difference between first rotation information of a first motor and second rotation information of a second motor according to an embodiment of the present disclosure, FIGS. 18 to 20 are partial perspective and exploded views illustrating a vehicle steering apparatus according to an embodiment of the present disclosure, FIG. 21 is a cross-sectional view illustrating a vehicle steering apparatus according to an embodiment of the present disclosure, FIGS. 22 and 23 are partial perspective and exploded views illustrating a vehicle steering apparatus according to an embodiment of the present disclosure, FIG. 24 is a cross-sectional view illustrating a vehicle steering apparatus according to an embodiment of the present disclosure, FIG. 25 is a partial perspective view illustrating a vehicle steering apparatus according to an embodiment of the present disclosure, and FIG. 26 is a cross-sectional view illustrating a vehicle steering apparatus according to an embodiment of the present disclosure.

A vehicle according to some embodiments of the present disclosure may include a ball nut 141, a first nut pulley 143a, a second nut pulley 143b, a first motor pulley 142a, a second motor pulley 142b, a anti-rotation member 150, a first motor sensor 145s, a second motor sensor 147s, and an electronic control device 110. The ball nut 141 may be rotatably coupled to a rack bar 130 by means of balls 144 and may be configured to slide the rack bar 130 in an axial direction by the rotation of the ball nut 141. The first and second nut pulleys 143a and 143b may be provided on an outer peripheral surface of the ball nut 141. The first motor pulley 142a may be provided on a first motor 145 (e.g. fixed to a shaft of the first motor 145) or directly formed on a rotatable part of the first motor 145 and connected to the first nut pulley 143a through a first belt 149a. The second motor pulley 142b may be provided on a second motor 147 (e.g. fixed to a shaft of the second motor 147) or directly formed on a rotatable part of the second motor 147 and connected to the second nut pulley 143b through a second belt 149b. The anti-rotation member 150 (e.g. an anti-rotation support) may support an outer peripheral surface of the rack bar 130 and may be coupled to an inner peripheral surface of a rack housing 160, and may be configured to prevent rotation of the rack bar 130. The first motor sensor 145s may be configured to detect a rotation position of a shaft 145a of the first motor 145. The second motor sensor 147s may be configured to detect a rotation position of a shaft 147a of the second motor 147. The electronic control device 110 may include one or more controllers or processors and may be configured to control the first and second motors 145 and 147. For instance, the electronic control device 110 may receive an electrical signal as an input value and control an output value to be transmitted to the first motor 145 and the second motor in response to the electrical signal.

The ball nut 141 may be operably coupled to the rack bar 130 by means of the balls and may be configured to linearly move or slide the rack bar 130 in the axial direction of the rack bar 130 by the rotation of the ball nut 141. The first and second nut pulleys 143a and 143b may be provided on the outer peripheral surface of the ball nut 141. The first motor pulley 142a may be provided on the first motor 145 and connected to the first nut pulley 143a through the first belt 149a. The second motor pulley 142b may be provided on the second motor 147 and connected to the second nut pulley 143b through the second belt 149b.

With reference to FIG. 1, in a steering apparatus according to the present disclosure, an angle sensor 105 and a torque sensor 107 may be coupled to one side of a steering shaft 103 connected to a steering wheel 101 or located around the steering shaft 103.

In an autonomous driving mode in which an autonomous driving system is driving the vehicle or in a driver assistance mode in which an driver assistance system such as an Advanced Driver Assistance System (ADAS) is assisting a driver with the operation of the vehicle, the electronic control device 110 controls a steering shaft motor 120, the first motor 145, and the second motor 147 by transmitting one or more control signals to the steering shaft motor 120, the first motor 145, and the second motor 147 in response to electrical signals transmitted from various sensors mounted in or to or associated with a vehicle.

In a driver driving mode, the electronic control device 110 controls the steering shaft motor 120, the first motor 145, and the second motor 147 by outputting one or more control signals to the steering shaft motor 120, the first motor 145, and the second motor 147 in response to electrical signals transmitted from the angle sensor 105, which detects a manipulation or rotation angle of the steering wheel 101 by the driver, electrical signals transmitted from the torque sensor 107, and electrical signals transmitted from various other sensors mounted in or to or associated with the vehicle.

In an embodiment illustrated in FIG. 1, the angle sensor 105 and the torque sensor 107 are provided as two separate and individual sensors. Alternatively, the angle sensor 105 and the torque sensor 107 may be integrated into one single sensor such as one torque angle sensor.

The steering shaft motor 120 may be connected to or associated with a speed reducer configured to reduce a rotational speed of the steering shaft motor 120 including, for example, but not limited to, one or more gears, one or more pulleys, and/or one or more belts.

During normal driving, the steering shaft motor 120 provides appropriate steering feedback to the driver by providing a reaction force to the steering shaft 103 so that the driver may feel a steering reaction force against the driver's manipulation of the steering wheel 101. The steering shaft motor 120 may be also referred to as a reaction force motor. However, as described below, the steering shaft motor 120 may not only provide the reaction force but also operate in accordance with autonomous steering when the steering shaft motor 120 operates in the autonomous driving mode.

In addition, the steering shaft motor 120 rotates the steering shaft 103 so that the autonomous steering can be performed under the control of the electronic control device 110 without the involvement of the driver's driving or intention when the steering shaft motor 120 operates in the autonomous driving mode.

Further, in a steer-by-wire steering apparatus, because the steering wheel 101 is not mechanically connected to the rack bar 130 and a road wheel 131, a device for mechanically restricting or limiting a rotatable range of the steering wheel 101 may be included to prevent the steering shaft 103 from rotating infinitely when the driver manipulates the steering wheel 101.

For example, a rotation angle restriction device 125 may be provided to restrict or limit a rotatable range of the steering wheel 101 to prevent the steering shaft 103 from rotating infinitely.

The first motor 145 and the second motor 147 move the rack bar 130 or cause the rack bar 130 to slide by a rack bar moving device 140 in order to steer the road wheels 131, which are provided at or connected to two opposite sides of the rack bar 130 through tie rods 133 and knuckle arms 135 by sliding the rack bar 130.

The rack bar moving device 140 includes the ball nut 141, the first nut pulley 143a, the second nut pulley 143b, the first motor pulley 142a, and the second motor pulley 142b. The ball nut 141 may be rotatably coupled to the rack bar 130 by means of the balls 144 and configured to slide the rack bar 130 in the axial direction of the rack bar moving device 140 by the rotation of the ball nut 141. The first nut pulley 143a may be provided on one side of the outer peripheral surface of the ball nut 141, and the second nut pulley 143b may be provided on the other side of the outer peripheral surface of the ball nut 141. The first motor pulley 142a may be coupled to the first motor 145 (e.g. fixed to a shaft of the first motor 145) or directly formed on a rotatable part of the first motor 145 and connected to the first nut pulley 143a through the first belt 149a. The second motor pulley 142b may be coupled to the second motor 147 (e.g. fixed to a shaft of the second motor 147) or directly formed on a rotatable part of the second motor 147 and connected to the second nut pulley 143b through the second belt 149a.

Further, the balls 144 are rotatably disposed between a rack screw groove, which is formed on an outer peripheral surface of the rack bar 130, and a nut screw groove, formed on an inner peripheral surface of the ball nut 141, such that the rack bar 130 can slides in the axial direction of the rack bar moving device 140 by the rotation of the ball nut 141.

However, in the embodiments of the present disclosure described above, the angle sensor 105 and the torque sensor 107 are provided on or around the steering shaft 103, and the steering apparatus according to an embodiment of the present disclosure may comprise a vehicle speed sensor 102, an ultrasonic sensor 104, and an image sensor 106 for transmitting steering information to the electronic control device 110. However, various types of sensors, such as a radar and a lidar, may be added to an embodiment of the present disclosure.

In a steer-by-wire steering apparatus, because the steering wheel 101 is not mechanically connected to the rack bar 130 and the road wheel 131, a device mechanically restricting the rack bar 130 may be included to prevent the rack bar 130 from being rotated by rotational torque of the ball nut 141 rotated by the rack bar moving device 140.

For instance, a rotation prevention member 150 is configured to support the axial sliding of the rack bar 130 and prevent the rotation of the rack bar 130.

In an embodiment illustrated in FIG. 1, one single rotation prevention member 150 is provided at one side of the rack bar 130. Alternatively, a plurality of the rotation prevention members 150 may be provided to support the rack bar 130. The number of the rotation prevention members 150, an axial position of the rotation prevention member 150, or the like may vary depending on the configuration and required operations of the first and second motors 145 and 147 and necessary rotational force of the ball nut 141 of the rack bar moving device 140.

In one embodiment illustrated in FIG. 1, the first motor 145 and the second motor 147 are arranged to face each other such that a shaft 145a of the first motor 145 and a shaft 147a of the second motor 147 are aligned coaxially and disposed in parallel with a central axis of the rack bar 130.

In an another embodiment illustrated in FIG. 2, the first motor 145 is disposed on one side of the rack bar 130 and the second motor 147 is disposed on the other side of the rack bar 130 such that the rack bar 130 is positioned between the shaft 145a of the first motor 145 and the shaft 147a of the second motor 147, and the shaft 145a of the first motor 145 and the shaft 147a of the second motor 147 are disposed in parallel with the central axis of the rack bar 130 and disposed on two opposite sides of the central axis of the rack bar 130.

As described above, the exemplary arrangements of the first and second motors 145 and 147 and the rack bar 130 illustrated in FIGS. 1 and 2 may reduce the package size of the steering apparatus, making it more compact in volume. and the process of assembling of the steering apparatus the first motor 145, the first belt 149a, the second motor 147, and the second belt 149b may be simplified.

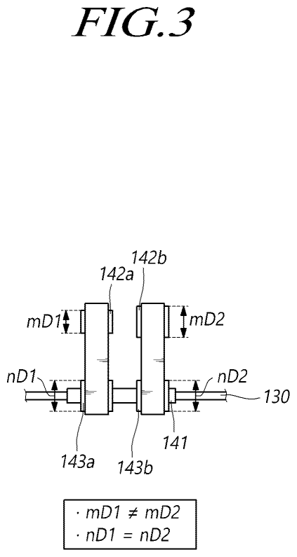

With reference to FIG. 3, an outer diameter mD1 of the first motor pulley 142a and an outer diameter mD2 of the second motor pulley 142b may be different from each other, and an outer diameter nD1 of the first nut pulley 143a and an outer diameter nD2 of the second nut pulley 143b may be equal to each other.

That is, the first nut pulley 143a and the second nut pulley 143b rotate while maintaining the same phase angle without a phase difference therebetween when the first motor 145 and the second motor 147 operate. The first motor pulley 142a and the second motor pulley 142b rotate while gradually changing a phase difference therebetween when the first motor 145 and the second motor 147 operate.

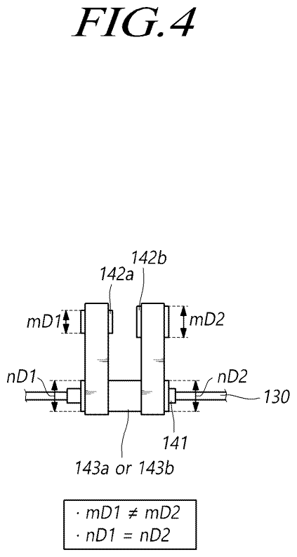

In an embodiment illustrated in FIG. 3, the first nut pulley 143a and the second nut pulley 143b are provided separately and connected to one portion and the other portion of the outer peripheral surface of the ball nut 141. However, as illustrated in FIG. 4, the first nut pulley 143a and the second nut pulley 143b may be integrated as a single piece having the same outer diameter. This will be described below.

The first motor 145 may have a first motor sensor 145s configured to detect a rotation position of the shaft 145a of the first motor 145, and the second motor 147 may have a second motor sensor 147s configured to detect a rotation position of the shaft 147a of the second motor 147.

When the first motor 145 operates, the first motor sensor 145s detects a direction and an angle of rotation of the shaft 145a of the first motor 145, and the first motor sensor 145s outputs a signal indicative of the direction and the angle to the electronic control device 110.

When the second motor 147 operates, the second motor sensor 147s detects a direction and an angle of rotation of the shaft 147a of the second motor 147, and the second motor sensor 147s outputs a signal indicative of the direction and the angle of the rotation of the shaft 147a of the second motor 147 to the electronic control device 110. When the second motor 147 operates, the second motor sensor 147s detects a direction and an angle of rotation of the shaft 147a of the second motor 147, and the second motor sensor 147s outputs a signal indicative of the direction and the angle of rotation of the shaft 147a of the second motor 147 to the electronic control device 110.

Therefore, the electronic control device 110 may determine a linear position of the rack bar 130 based on a first position of the shaft 145a of the first motor 145 detected by the first motor sensor 145s and a second position of the shaft 147a of the second motor 147 detected by the second motor sensor 147s and output a control signal to the first motor 145 and the second motor 147.

That is, the electronic control device 110 sets an angle between a reference point of the shaft 145a of the first motor 145 in a stopped state of the first motor 145 and a reference point of the shaft 147a of the second motor 147 in a stopped state of the second motor 147 to a reference position value. The electronic control device 10 sets an angle between the reference point of the shaft 145a of the first motor 145 and the reference point of the shaft 147a of the second motor 147 after the operations of the first and second motors 145 and 147 to an operating position value. The electronic control device 10 determines the linear position of the rack bar 130 based on a difference between the reference position value and the operating position value.

For instance, the difference between the reference position value and the operating position value may be set to 0° to 360°. A maximum slidable amount of the rack bar 130 is set within this range. The electronic control device 110 determines the slidable position of the rack bar 130 based on at least one of a rotation ratio between the first motor pulley 142a and the first nut pulley 143a, a rotation ratio between the second motor pulley 142b and the second nut pulley 143b, an outer diameter and an inner diameter of the ball nut 141, an outer diameter of the rack bar 130, or a lead angle between the rack screw groove 130a and the nut screw groove 141a.

In addition, the electronic control device 110 may determine the linear position of the rack bar 130 by setting the difference between the reference position value and the operating position value to a movement value and comparing the movement value with preset data. For instance, the movement value may be set to 0° to 360°, and the maximum slidable amount of the rack bar 130 may be set within this range.

The preset data may be data including the sliding amount of the rack bar 130 corresponding to the movement value determined based on at least one of the outer diameters of the first and second motor pulleys 142a and 142b, the outer diameters of the first and second nut pulleys 143a and 143b, the outer and inner diameters of the ball nut 141, and/or the outer diameter of the rack bar 130.

For example, the first motor pulley 142a and the second motor pulley 142b have different outer diameters, and the first nut pulley 143a and the second nut pulley 143b have the same outer diameter, such that the electronic control device 110 may determine the sliding position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

With reference to FIG. 4, the first nut pulley 143a and the second nut pulley 143b may be integrated to a single piece having the same outer diameter.

In an example that the first nut pulley 143a and the second nut pulley 143b are integrated to a single piece having the same outer diameter, the first belt 149a is coupled to one portion of the integrated pulley, and the second belt 149b is coupled to the other portion of the integrated pulley, such that the first belt 149a and the second belt 149b may be respectively connected to the first motor pulley 142a and the second motor pulley 142b.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

When the first motor 145 operates, the first motor sensor 145s detects the direction and the angle of the rotation of the shaft 145a of the first motor 145, and the first motor sensor 145s transmits the direction and the angle to the electronic control device 110.

When the second motor 147 operates, the second motor sensor 147s detects the direction and the angle of the rotation of the shaft 147a of the second motor 147 rotates, and the second motor sensor 147s transmits a signal indicative of the direction and the angle to the electronic control device 110.

Therefore, the electronic control device 110 may determine the linear position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

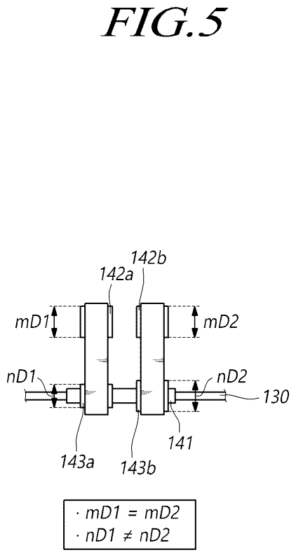

In an exemplary embodiment illustrated in FIG. 5, the outer diameter mD1 of the first motor pulley 142a and the outer diameter mD2 of the second motor pulley 142b may be equal to each other, and the outer diameter nD1 of the first nut pulley 143a and the outer diameter nD2 of the second nut pulley 143b may be different from each other.

The first nut pulley 143a, the second nut pulley 143b, and the ball nut 141 rotate at the same speed. Therefore, the first nut pulley 143a and the second nut pulley 143b maintain the same phase angle and rotate without a phase difference when the first motor 145 and the second motor 147 operate. However, the first motor pulley 142a and the second motor pulley 142b rotate while gradually changing a phase difference.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

When the first motor 145 operates, the first motor sensor 145s detects the direction and the angle of rotation of the shaft 145a of the first motor 145, and the first motor sensor 145s outputs a signal indicative of the direction and the angle of the rotation of the shaft 145a of the first motor 145 to the electronic control device 110.

Further, when the second motor 147 operates, the second motor sensor 147s detects the direction and the angle of rotation of the shaft 147a of the second motor 147, and the second motor sensor 147s transmits the direction and the angle of the rotation of the shaft 147a of the second motor 147 to the electronic control device 110.

Therefore, the electronic control device 110 may output a signal for controlling the first motor 145 and the second motor 147 by determining the linear position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

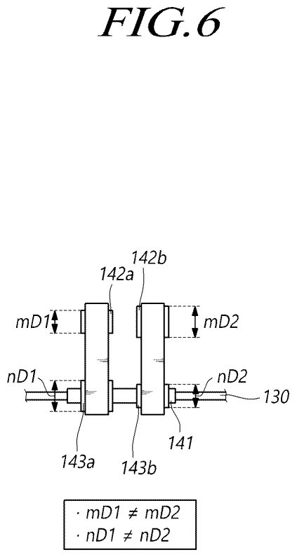

In an exemplary embodiment shown in FIG. 6, the outer diameter mD1 of the first motor pulley 142a and the outer diameter mD2 of the second motor pulley 142b may be different from each other, and the outer diameter nD1 of the first nut pulley 143a and the outer diameter nD2 of the second nut pulley 143b may also be different from each other.

Even in this case, the first nut pulley 143a, the second nut pulley 143b, and the ball nut 141 rotate at the same speed. Therefore, the first nut pulley 143a and the second nut pulley 143b maintain the same phase angle and rotate without a phase difference when the first motor 145 and the second motor 147 operate.

Further, the first motor pulley 142a and the second motor pulley 142b rotate while gradually changing a phase difference when the first motor 145 and the second motor 147 operate.

The first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the linear position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

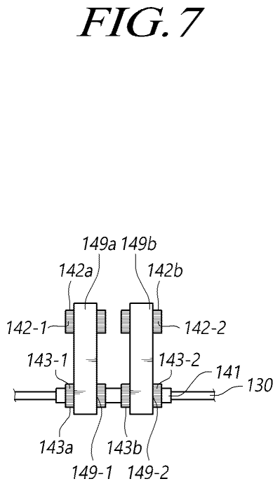

In an exemplary embodiment of FIG. 7, first motor pulley teeth 142-1 are provided on an outer peripheral surface of the first motor pulley 142a, and first nut pulley teeth 143-1 are provided on an outer peripheral surface of the first nut pulley 143a. The first motor pulley teeth 142-1 and the first nut pulley teeth 143-1 may be coupled to first belt teeth 149-1 provided on an inner peripheral surface of the first belt 149a.

Because the first motor pulley teeth 142-1 and the first nut pulley teeth 143-1 are coupled to the first belt teeth 149-1 to transmit power, the first motor pulley teeth 142-1 and the first nut pulley teeth 143-1 have the same size as the first belt teeth 149-1.

Second motor pulley teeth 142-2 are provided on an outer peripheral surface of the second motor pulley 142b, and second nut pulley teeth 143-2 are provided on an outer peripheral surface of the second nut pulley 143b. The second motor pulley teeth 142-2 and the second nut pulley teeth 143-2 may be coupled to second belt teeth 149-2 provided on an inner peripheral surface of the second belt 149b.

Because the second motor pulley teeth 142-2 and the second nut pulley teeth 143-2 are coupled to the second belt teeth 149-2 to transmit power, the second motor pulley teeth 142-2 and the second nut pulley teeth 143-2 may have the same size as the second belt teeth 149-2.

Further, the number of the first motor pulley teeth 142-1 and the number of the second motor pulley teeth 142-2 may be different from each other, and the number of the first nut pulley teeth 143-1 and the number of the second nut pulley teeth 143-2 may be equal to each other.

The first motor pulley teeth 142-1 and the second motor pulley teeth 142-2 have an equal circumferential pitch, different pitch circle diameters, and a different number of teeth from each other. The first nut pulley teeth 143-1 and the second nut pulley teeth 143-2 have an equal circumferential pitch, an equal pitch circle diameter, and a different number of teeth.

The first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may determine the linear position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

That is, like the above-mentioned determination method, the difference between the reference position value and the operating position value may be set to 0° to 360°, and the maximum slidable amount of the rack bar 130 is set within this range. The electronic control device 110 determines the sliding position of the rack bar 130 on the basis of at least one of a pitch circle diameter ratio or a tooth number ratio between the first motor pulley 142a and the first nut pulley 143a, a pitch circle diameter ratio or a tooth number ratio between the second motor pulley 142b and the second nut pulley 143b, the outer and inner diameters of the ball nut 141, or the outer diameter of the rack bar 130.

In addition, like the above-mentioned determination method, the electronic control device 110 may determine the sliding position of the rack bar 130 by setting the difference between the reference position value and the operating position value to the movement value and comparing the movement value with preset data. In this case, the movement value may be set to 0° to 360°, and the maximum slidable amount of the rack bar 130 is set within this range.

In this case, the preset data may be data including the sliding amount of the rack bar 130 corresponding to the movement value determined based on at least one of the pitch circle diameters and the number of teeth of the first and second motor pulleys 142a and 142b, the pitch circle diameters and the number of teeth of the first and second nut pulleys 143a and 143b, the outer and inner diameters of the ball nut 141, and/or the outer diameter of the rack bar 130.

As described above, the number of the first motor pulley teeth 142-1 and the number of the second motor pulley teeth 142-2 are different, and the number of the first nut pulley teeth 143-1 and the number of the second nut pulley teeth 143-2 are equal. The electronic control device 110 may output a signal for controlling the first motor 145 and the second motor 147 by determining the sliding position of the rack bar 130 on the basis of the first position of the shaft 145a of the first motor 145 sensed by the first motor sensor 145s and the second position of the shaft 147a of the second motor 147 detected by the second motor sensor 147s.

In addition, the number of the first motor pulley teeth 142-1 and the number of the second motor pulley teeth 142-2 may be equal, and the number of the first nut pulley teeth 143-1 and the number of the second nut pulley teeth 143-2 may be different.

The first motor pulley teeth 142-1 and the second motor pulley teeth 142-2 have an equal circumferential pitch and an equal pitch circle diameter, and the same number of teeth. The first nut pulley teeth 143-1 and the second nut pulley teeth 143-2 have an equal circumferential pitch, and different pitch circle diameters and the different number of teeth.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the sliding position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

In addition, the number of the first motor pulley teeth 142-1 and the number of the second motor pulley teeth 142-2 may be different, and the number of the first nut pulley teeth 143-1 and the number of the second nut pulley teeth 143-2 may be different.

That is, the first motor pulley teeth 142-1 and the second motor pulley teeth 142-2 may have an equal circumferential pitch and different pitch circle diameters, and different number of teeth. The first nut pulley teeth 143-1 and the second nut pulley teeth 143-2 have an equal circumferential pitch, different pitch circle diameters, and different number of teeth.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the sliding position of the rack bar 130 through the above-mentioned determination process based on the first position of the shaft 145a of the first motor 145 detected by the first motor sensor 145s and the second position of the shaft 147a of the second motor 147 the second motor sensor 147s.

In an exemplary embodiment of FIG. 8, in order to prepare for a case in which any one of the first motor sensor 145s and the second motor sensor 147s is inoperable, a rotary gear 139, rotatably engaged with a rack gear 130b provided on the rack bar 130, may be rotatably coupled to the rack bar 130, and a rotation angle sensor 137s may be configured to detect a rotation angle of the rotary gear 139.

The rotary gear 139 may be configured to be rotatable while being supported on a rack housing by means of a bearing. The rotation angle sensor 137s may be installed on or around a shaft 137 of the rotary gear 139 and configured to detect a rotation angle of the rotary gear 139 and transmit the rotation angle of the rotary gear 139 to the electronic control device 110.

Therefore, even when any one of the first motor sensor 145s and the second motor sensor 147s is inoperable, the electronic control device 110 may output a signal for controlling the first motor 145 and the second motor 147 by determining the sliding position of the rack bar 130 based on the pre-stored gear ratio between the rack gear 130b and the rotary gear 139 and the rotation angle of the rotary gear 139 received from the rotation angle sensor 137s.

Meanwhile, hereinafter, various embodiments of a rotation prevention member or means may be provided in the above-mentioned steering apparatus.

Some embodiments of the rotation prevention member 150 will be described below more specifically with reference to FIGS. 9 to 18.

As illustrated in FIG. 9, the rotation prevention member 150 may be coupled to one radial side and the other radial side of the rack bar 130 and support two opposite sides of the rack bar 130, thereby preventing the rack bar 130 from rotating.

The rotation prevention member 150 may include a shaft 230 configured to support a support surface 130-1 formed on the outer peripheral surface of the rack bar 130, and a support yoke 240 configured to support the outer peripheral surface of the rack bar 130 opposite or corresponding to a position at which the shaft 230 is supported.

The support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and formed as a curved surface, a flat surface, or combination thereof.

The support surface 130-1 extends in an axial direction of the rack bar 130 so as to be supported by the shaft 230 when the rack bar 130 slides in the axial direction of the rack bar 130.

Optionally, a coating layer may be provided on the support surface 130-1 and made of a low-friction material having a low frictional coefficient, such as fluorine resin or ceramic, in order to minimize or reduce friction with the shaft 230.

The shaft 230, which supports the support surface 130-1 of the rack bar 130, may include an upper end support portion 231, a body portion 233, and a lower end support portion 235.

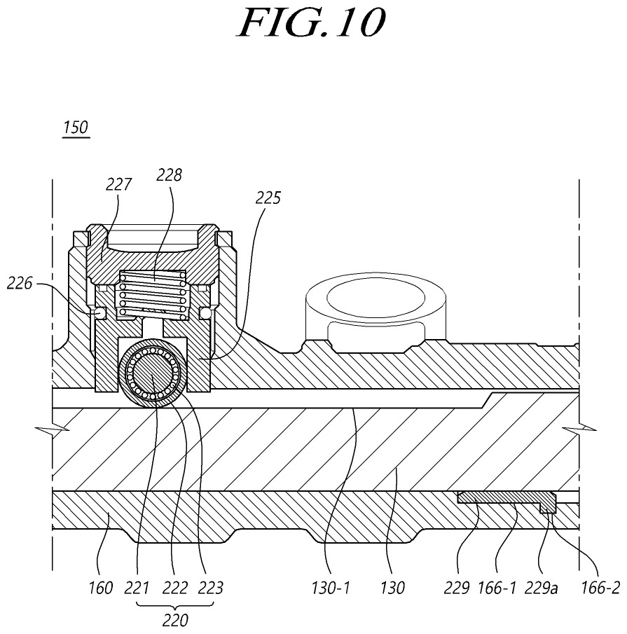

When the rack bar 130 slides, the shaft 230 is supported by a rack housing (e.g., 160 of FIG. 10) and is configured to be rotatable such that the body portion 233 supports the support surface 130-1 of the rack bar 130, thereby preventing the rack bar 130 from rotating.

A needle bearing 236 may be coupled to the body portion 233 to minimize or reduce friction with the support surface 130-1 of the rack bar 130.

The upper end support portion 231, which has a larger diameter than the body portion 233, may be provided above the body portion 233, and an upper end bearing 234 may be coupled to the upper end support portion 231 so as to be rotatably supported on the rack housing.

A top plug 232 may be coupled to an upper side of the upper end support portion 231 in order to prevent foreign substances from being introduced into the rack housing.

The lower end support portion 235, which has a smaller diameter than the body portion 233, may be provided below the body portion 233, and a lower end bearing 238 may be coupled to the lower end support portion 235 so as to be rotatably supported on the rack housing.

The support yoke 240, which supports the outer peripheral surface of the rack bar 130 opposite to a position at which the shaft 230 is supported, supports the rack bar 130 toward the shaft 230 when the rack bar 130 slides, thereby preventing the rack bar 130 from rotating.

A curved surface support portion 241 may be formed at an end portion of the support yoke 240 and may be supported on and closely contacted with the outer peripheral surface of the rack bar 130. The curved surface support portion 241 may have a curved surface identical to the outer peripheral surface of the rack bar 130.

The support yoke 240 may have predetermined rigidity and elasticity and may be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

An elastic ring 245 may be coupled to an outer peripheral surface of the support yoke 240 to prevent rattle noise with the rack housing.

One or more elastic rings 245 may be coupled to the outer peripheral surface of the support yoke 240.

The elastic ring 245 may be made of a material capable of absorbing vibration and noise and having predetermined elasticity and rigidity. For instance, the elastic ring 245 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A yoke plug 243 may be coupled to an end portion of the support yoke 240, press-fitted or screw-coupled to the rack housing, and fix the support yoke 240.

Further, an elastic body may be coupled between the support yoke 240 and the yoke plug 243 and elastically support the support yoke 240 toward the rack bar 130.

As illustrated in FIG. 10, the rotation prevention member 150 may be coupled to one radial side and the other radial side of the rack bar 130 and support two opposite sides of the rack bar 130, thereby preventing the rack bar 130 from rotating.

The rotation prevention member 150 may include a needle bearing 220 configured to support the support surface 130-1 formed on the outer peripheral surface of the rack bar 130, a support yoke 225 rotatably coupled to the needle bearing 220, and a rack bushing 229 configured to support the outer peripheral surface of the rack bar 130 opposite to a position at which the needle bearing 220 is supported.

The support surface 130-1 may be formed on the outer peripheral surface of the rack bar 130. For instance, the support surface 130-1 may be formed by machining or grinding the outer peripheral surface of the rack bar 130.

The support surface 130-1 may be recessed from the outer peripheral surface of the rack bar 130. The support surface 130-1 may be formed as a curved surface or a flat surface.

The support surface 130-1 is elongated in the axial direction of the rack bar 130. And, the support surface 130-1 may be supported by the needle bearing 220 when the rack bar 130 slides in the axial direction of the rack bar 130.

A coating layer may be provided on the support surface 130-1 and made of a low-friction material, such as fluorine resin or ceramic, in order to minimize or reduce friction with the needle bearing 220.

The needle bearing 220 may be configured to support the support surface 130-1 of the rack bar 130, the needle bearing 220 may have a support shaft 221 provided at a central portion of the needle bearing 220, and the support shaft 221 is fixed to the support yoke 225 so that the needle bearing 220 may be rotatably supported by the support yoke 225.

An outer race 222 of the needle bearing 220 is supported on the support surface 130-1 and is configured to rotate when the rack bar 130 slides in order to prevent the rack bar 130 from rotating.

The outer race 222 of the needle bearing 220 may be disposed at a position protruding from an end portion of the support yoke 225 so that the outer race 222 may be supported on the support surface 130-1.

The support yoke 225 supports the needle bearing 220 toward the support surface 130-1 when the rack bar 130 slides in order to prevent the rotation of the rack bar 130.

The support yoke 225 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

An elastic ring 226 may be coupled to the outer peripheral surface of the support yoke 225 to prevent rattle noise with the rack housing 160.

One or more elastic rings 226 may be coupled to the outer peripheral surface of the support yoke 225.

The elastic ring 226 may be made of a material capable of absorbing vibration and noise and having predetermined elasticity and rigidity. Therefore, the elastic ring 226 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A yoke plug 227 may be coupled to an end of the support yoke 225, press-fitted or screw-coupled to the rack housing 160, and configured to fix the position of the support yoke 225.

Further, an elastic body 228 may be coupled between the support yoke 225 and the yoke plug 227 and elastically support the support yoke 225 by applying an elastic force toward the rack bar 130.

The rack bushing 229, which supports the outer peripheral surface of the rack bar 130 opposite to another outer peripheral surface of the rack bar 130 which the needle bearing 220 supports, may be formed in a semi-cylindrical shape made by cutting a part of an outer peripheral surface thereof.

The rack bushing 229 supports the rack bar 130 toward the needle bearing 220 in the radial direction of the rack bushing 229 when the rack bar 130 slides, thereby preventing the rack bar 130 from rotating.

The rack bushing 229 may have a curved surface identical to or corresponding to the outer peripheral surface of the rack bar 130 so as to be closely contacted with and supported on the outer peripheral surface of the rack bar 130.

A bushing coupling groove 166-1, to which the rack bushing 229 is coupled, may be formed on an inner peripheral surface of the rack housing 160.

The rack bushing 229 may have a fixing protrusion 229a formed on or around an end portion of an outer peripheral surface of the rack bushing 229 in order to prevent the axial position of the rack bushing 229 from being separated or rotated when the rack bar 130 slides.

A fixing groove 166-2 may be formed on the inner peripheral surface of the rack housing 160, and the fixing protrusion 229a of the rack bushing 229 may be coupled to the fixing groove 166-2 of the rack housing 160.

The rack bushing 229 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

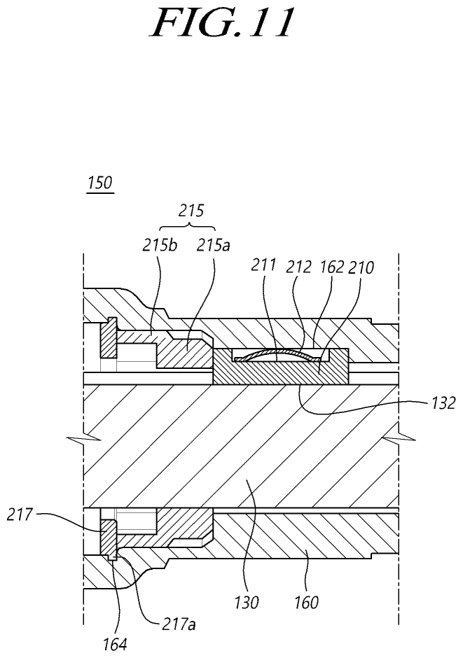

In an embodiment illustrated in FIG. 11, the rotation prevention member 150 may be configured to prevent the rack bar 130 from rotating about the central axis of the rack bar 130. The rotation prevention member 150 supports the outer peripheral surface of the rack bar 130 and may be supported on the inner peripheral surface of the rack housing 160.

The rotation prevention member 150 may include a support member 210 having one end portion disposed or supported in a rack support groove 132 formed on the outer peripheral surface of the rack bar 130, and the other end portion disposed or supported in a housing groove 162 formed on the inner peripheral surface of the rack housing 160, and an elastic member 212 coupled to the support member 210 and configured to elastically support the inner peripheral surface of the rack housing 160.

The rack support groove 132 formed on the outer peripheral surface of the rack bar 130 may be formed by machining or grinding the outer peripheral surface of the rack bar 130.

The rack support groove 132 may be recessed from the outer peripheral surface of the rack bar 130. The rack support groove 132 may have a curved surface or a flat surface.

The rack support groove 132 may be elongated in the axial direction of the rack bar 130 and be supported by the support member 210 when the rack bar 130 slides in the axial direction of the rack bar 130.

A coating layer may be provided on the rack support groove 132 and made of a low-friction material, such as fluorine resin or ceramic, in order to reduce or minimize friction with the support member 210.

The housing groove 162, in which the other end portion of the support member 210 is supported, may be formed at a position facing the rack support groove 132 in the radial direction of the rack bar 130.

For example, the housing groove 162 may be formed by machining or grinding the inner peripheral surface of the rack housing 160.

The housing groove 162 may be recessed from the inner peripheral surface of the rack housing 160 and have a curved surface or a flat surface so that the support member 210 can prevent the rotation of the rack bar 130 when the rack bar 130 slides in the axial direction of the rack bar 130.

One end portion and the other end portion of the support member 210 are coupled to the rack support groove 132 and the housing groove 162, respectively, and a coupling groove 211, to which the elastic member 212 is coupled, is formed at the other end portion of the support member 210.

The support member 210 may have predetermined rigidity and elasticity and be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

The elastic member 212 is coupled to the coupling groove 211 of the support member 210, supports the support member 210 and is configured to apply elastic force toward the rack bar 130 while being elastically supported on the inner peripheral surface of the rack housing 160, such that the support member 210 maintains a predetermined interval so as not to collide with the inner peripheral surface of the rack housing 160 when the rack bar 130 slides in the axial direction of the rack bar 130. Therefore, rattle noise between the support member 210 and the rack housing 160 may be prevented.

For example, the elastic member 212 may be formed as an arcuate thin board.

A plug bolt 215 may be disposed at an axial end of the support member 210, may be configured to prevent the separation of the support member 210, and may be coupled to the inner peripheral surface of the rack housing 160. For instance, the plug bolt 215 may be press-fitted and coupled to the inner peripheral surface of the rack housing 160.

The plug bolt 215 includes a support portion 215a configured to support the support member 210 in the axial direction of the rack bar 130, and a fixing portion 215b extended from the support portion 215a and fixed to the inner peripheral surface of the rack housing 160.

The outer peripheral surface of the fixing portion 215b has a threaded portion screw-coupled to the inner peripheral surface of the rack housing 160.

Further, a fixing member 217 may be coupled to an axial end of the plug bolt 215 in order to prevent the plug bolt 215 from being loosened and separated.

A fixing protrusion 217a protruding in the radial direction of the rack housing 160 may project from an outer peripheral surface of the fixing member 217.

A fixing groove 164 may be formed on the inner peripheral surface of the rack housing 160, and the fixing protrusion 217a of the fixing member 217 may be inserted into and supported by the fixing groove 164.

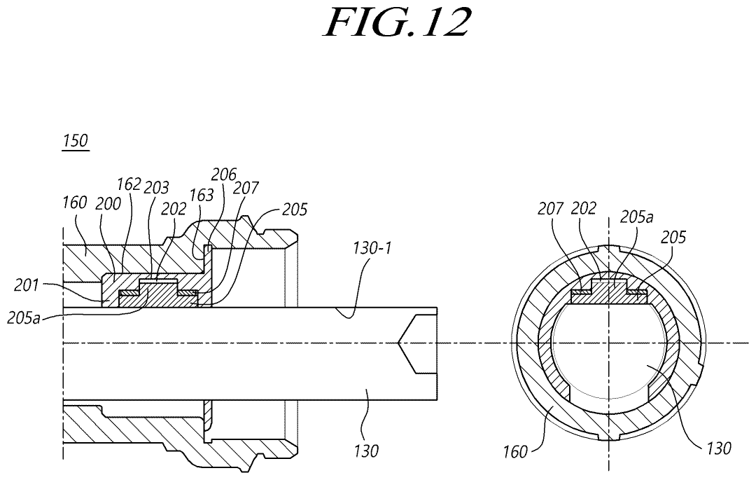

In an embodiment of FIG. 12, the rotation prevention member 150 may be supported on the outer peripheral surface of the rack bar 130 and the inner peripheral surface of the rack housing and prevent the rack bar 130 from rotating about the central axis.

The rotation prevention member 150 may include a support bushing 205 configured to support the support surface 130-1 formed on the outer peripheral surface of the rack bar 130, a bushing holder 200 coupled to the outer peripheral surface of the rack bar 130 and having an inner peripheral surface on which the support bushing 205 is supported, and an elastic member 207 coupled between the bushing holder 200 and the support bushing 205 and configured to elastically support the support bushing 205 by apply elastic force toward the rack bar 130.

For example, the support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and may have a curved surface or a flat surface.

The support surface 130-1 is elongated in the axial direction of the rack bar 130 and is supported by the support bushing 205 when the rack bar 130 slides in the axial direction.

A coating layer may be provided on the support surface 130-1 and made of a low-friction material, such as fluorine resin or ceramic, in order to minimize or reduce friction with the support bushing 205.

The housing groove 162, to and in which the bushing holder 200 is coupled and supported, is formed on the inner peripheral surface of the rack housing 160, and is positioned to face the support surface 130-1 in the radial direction of the rack bar 130.

For example, the housing groove 162 may be formed by machining or grinding the inner peripheral surface of the rack housing 160.

The housing groove 162 may be recessed from the inner peripheral surface of the rack housing 160 and may have a curved surface or a flat surface.

In addition, a stepped projection portion 163 having a larger diameter at an end portion of the housing groove 162 may be formed on the inner peripheral surface of the rack housing 160, and an end portion of the stepped projection portion 163 may have an opening in the axial direction of the rack bar 130.

The bushing holder 200 has a cylindrical shape. For instance, the bushing holder 200 may have a cut-out portion made by cutting one radial side of the bushing holder 200, and an inner peripheral protruding surface 201 which protrudes radially inward.

Further, a bushing coupling groove 203, to which the support bushing 205 is coupled, may be formed on the inner peripheral protruding surface 201. A flange portion 206 protrudes in the radial direction, is supported by or on the stepped projection portion 163 of the rack housing 160, and may be formed at an axial end of the bushing holder 200.

The flange portion 206 is supported by or on the stepped projection portion 163 to prevent the separation of the bushing holder 200 when the rack bar 130 slides in the axial direction.

The support bushing 205 coupled to the bushing coupling groove 203 of the bushing holder 200 includes a protruding support portion 205a protruding from a central portion of the support bushing 205, and the elastic member 207 is coupled to the protruding support portion 205a.

For example, the elastic member 207 may be formed in an annular shape and formed in a cone shape in which an inner peripheral surface and an outer peripheral surface of the elastic member 207 are stepped in the axial direction such that the protruding support portion 205a may be coupled to an inner peripheral surface of the elastic member 207.

The elastic member 207 elastically supports the support bushing 205 to apply elastic force toward the rack bar 130 and the elastic member 207 may be positioned between the bushing holder 200 and the support bushing 205, thereby forming a gap or space 202 so that the support bushing 205 cannot collide with the bushing holder 200 when the rack bar 130 slides in the axial direction to prevent or reduce rattle noise between the support bushing 205 and the bushing holder 200.

The bushing holder 200 and the support bushing 205 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

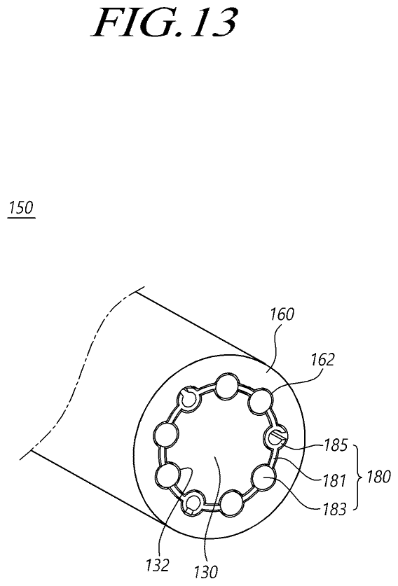

In an embodiment illustrated in FIG. 13, the rotation prevention member 150 may support the outer peripheral surface of the rack bar 130 to prevent the rack bar 130 from rotating about the central axis and is supported by the inner peripheral surface of the rack housing.

The rotation prevention member 150 may include a rack bushing 180 having one or more rotation support portions 183 rotatably disposed between the rack support groove 132 formed on the outer peripheral surface of the rack bar 130 and the housing groove 162 formed on the inner peripheral surface of the rack housing 160, an elastic support portion 185 disposed between and elastically supported by the rack support groove 132 formed on the outer peripheral surface of the rack bar 130 and the housing groove 162 formed on the inner peripheral surface of the rack housing 160, and a connection portion 181 connecting the rotation support portion 183 and the elastic support portion 185.

The rack support groove 132 may be formed on the outer peripheral surface of the rack bar 130. For instance, the rack support groove 132 may be formed by machining or grinding the outer peripheral surface of the rack bar 130.

The rack support groove 132 may be recessed from the outer peripheral surface of the rack bar 130, and include a curved surface or a flat surface.

The rack support groove 132 is elongated in the axial direction of the rack bar 130 and is supported by the rotation support portion 183 and the elastic support portion 185 when the rack bar 130 slides in the axial direction. The rotation support portion 183 and the elastic support portion 185 may be disposed in the rack support groove 132.

The housing groove 162 is formed on the inner peripheral surface of the rack housing 160 at the position facing or corresponding to the rack support groove 132 in the radial direction.

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

A coating layer may be provided on the rack support groove 132 and the housing groove 162 and made of a low-friction material, such as fluorine resin or ceramic, in order to minimize or reduce friction with the rack bushing 180.

The rack bushing 180 may have two or more rotation support portions 183 and/or two or more elastic support portions 185.

Balls may be coupled to the rotation support portions 183, and the balls may be spaced apart from one another in the axial direction.

The elastic support portion 185 may have a substantially cylindrical shape. The elastic support portion 185 may have an opening at one side thereof.

The rack bushing 180 is elastically supported by the rack support groove 132 and the housing groove 162 by an elastic deformation force of the elastic support portion 185, thereby maintaining a predetermined interval so that the rack bushing 180 does not collide with the rack housing 160 when the rack bar 130 slides in the axial direction to prevent rattle noise between the rack bushing 180 and the rack housing 160.

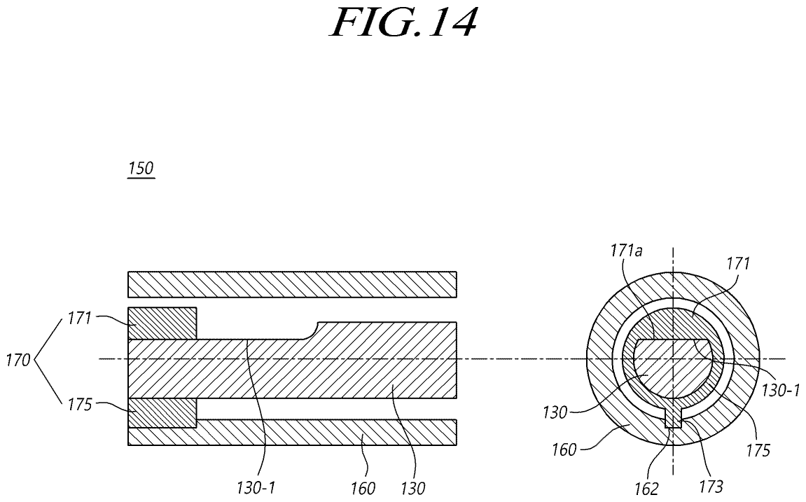

In an embodiment illustrated in FIG. 14, the rotation prevention member 150 may support the outer peripheral surface of the rack bar 130 to prevent the rack bar 130 from rotating about the central axis and the rotation prevention member 150 may be supported by the inner peripheral surface of the rack housing 160.

The rotation prevention member 150 may include a rack bushing 170 having a first support portion 171 and a second support portion 175. The first support portion 171 may be configured to support the support surface 130-1 formed on the outer peripheral surface of the rack bar 130. The second support portion 175 may be extended from or connected to the first support portion 171, may be configured to support the outer peripheral surface of the rack bar 130, and may have an outer peripheral surface on which a fixing protrusion 173, which is coupled to the housing groove 162 formed on the inner peripheral surface of the rack housing 160.

For example, the support surface 130-1 formed on a part of the outer peripheral surface of the rack bar 130 may be formed by machining or grinding the outer peripheral surface of the rack bar 130.

The support surface 130-1 may be recessed from the outer peripheral surface of the rack bar 130 and may have a curved surface or a flat surface.

The support surface 130-1 is elongated in the axial direction of the rack bar 130 so as to be supported by the first support portion 171 when the rack bar 130 slides in the axial direction.

An inner peripheral surface 171a of the first support portion 171 may be closely contacted with and supported by the support surface 130-1 of the rack bar 130, and an outer peripheral surface of the first support portion 171 may be spaced apart from the inner peripheral surface of the rack housing 160.

A coating layer may be provided on the support surface 130-1 and the outer peripheral surface of the rack bar 130 and made of a low-friction material, such as fluorine resin or ceramic, in order to minimize or reduce friction with the rack bushing 170.

The second support portion 175 is extended from or connected to the first support portion 171 in the circumferential direction and surrounds the outer peripheral surface of the rack bar 130.

The fixing protrusion 173 protrudes from the outer peripheral surface of the second support portion 175 in the radial direction.

The housing groove 162 may be formed on the inner peripheral surface of the rack housing 160, and the fixing protrusion 173 of the second support portion 175 may be inserted in or coupled to the housing groove 162, thereby preventing the rack bushing 170 from rotating.

For example, the housing groove 162 may be formed by machining or grinding the inner peripheral surface of the rack housing 160.

The housing groove 162 may be recessed from the inner peripheral surface of the rack housing 160 and may have a curved surface or a flat surface.

The rack bushing 170 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

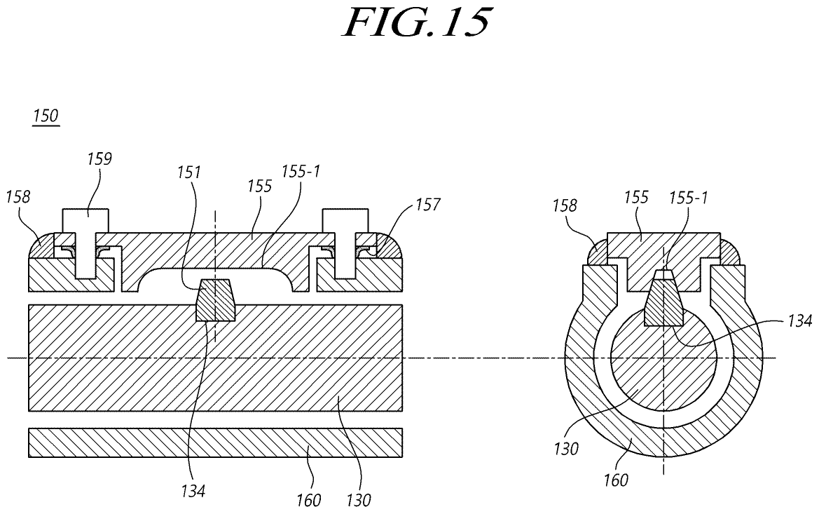

In an embodiment illustrated in FIG. 15, the rotation prevention member 150 may be supported by a guide cover 155, which is coupled to the rack housing 160, and may support the outer peripheral surface of the rack bar 130 to prevent the rack bar 130 from rotating about the central axis.

The rotation prevention member 150 may include a support member 151 coupled to the outer peripheral surface of the rack bar 130, the guide cover 155 coupled to the rack housing 160 and having an inner peripheral surface which the support member 151 supports, and a fastener 159 configured to fix the guide cover 155 to the rack housing 160.

The support member 151 may be coupled to the outer peripheral surface of the rack bar 130. For instance, the support member 151 may be coupled, by press-fitting, bonding, or the like, to a coupling groove 134 formed on the outer peripheral surface of the rack bar 130. The coupling groove 134 may be formed by machining or grinding the outer peripheral surface of the rack bar 130.

The coupling groove 134 may be recessed from the outer peripheral surface of the rack bar 130 and may have a curved surface or a flat surface.

The rack housing 160 may have an opening at a position facing or corresponding to the support member 151, and the guide cover 155 is coupled to and covers the opening of the rack housing 160.

The inner peripheral surface of the guide cover 155 may have a support groove 155-1 into and by which the support member 151 is inserted and supported.

The support groove 155-1 of the guide cover 155 is elongated in the axial direction of the rack bar 130 so that the support member 151 may be supported by the support groove 155-1 when the rack bar 130 slides in the axial direction.

The support groove 155-1 may have, for example, but not limited to, a trapezoidal shape having a width that increases toward the support member 151.

The support member 151 may have a trapezoidal shape having a width that decreases from the outer peripheral surface of the rack bar 130 toward the support groove 155-1.

Two opposite side surfaces of the support groove 155-1 may be closely contacted with and supported by the support member 151, and an inner top surface of the support groove 155-1 positioned between the two opposite side surfaces of the support groove 155-1 may be spaced apart from an end of the support member 151.

A coating layer may be provided on the support groove 155-1 or the support member 151 and made of a low-friction material, such as fluorine resin or ceramic, in order to reduce or minimize friction.

The support groove 155-1 may have grease therein in order to minimize friction with the support member 151.

The guide cover 155 may be fixed to the rack housing 160 by the fastener 159.

Further, an elastic member 157 may be disposed between the guide cover 155 and the rack housing 160, penetrated by the fastener 159, and configured to elastically support the guide cover 155 and the rack housing 160.

A sealing member or seal 158 may be applied onto the ends of the guide cover 155 and the outer peripheral surface of the rack housing 160 in order to prevent moisture or dust from being introduced from the outside of the rack housing 160.

The support member 151 and the guide cover 155 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

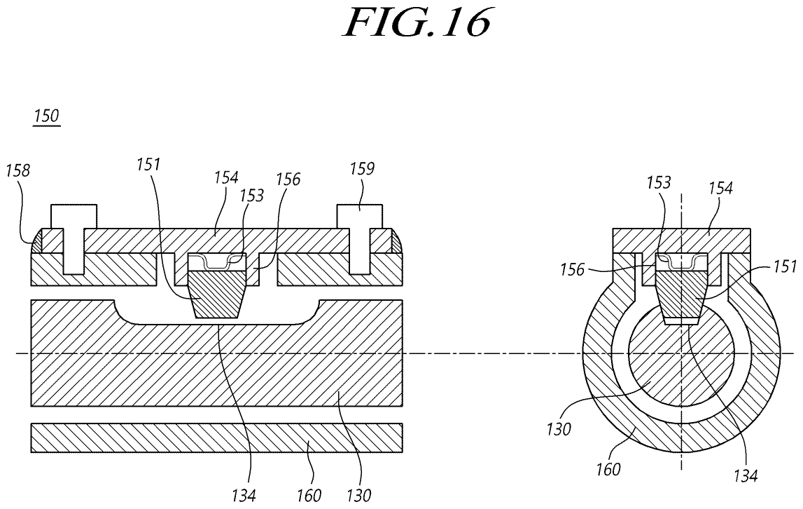

In an embodiment illustrated in FIG. 16, the rotation prevention member 150 may be supported by a housing cover 154, which is coupled to the rack housing 160, and the outer peripheral surface of the rack bar 130, thereby preventing the rack bar 130 from rotating about the central axis of the rack bar 130.

The rotation prevention member 150 may include the support member 151 supporting the outer peripheral surface of the rack bar 130, the housing cover 154 fixed to the rack housing 160 and having the inner peripheral surface to which the support member 151 is coupled, and the fastener 159 configured to fix the housing cover 154 to the rack housing 160.

A rack support groove 134 by which the support member 151 is supported is formed on the outer peripheral surface of the rack bar 130.

The rack support groove 134 is elongated or extended in the axial direction of the rack bar 130 so that the support member 151 may be supported by the rack support groove 134 when the rack bar 130 slides in the axial direction.

The rack support groove 134 may be recessed from the outer peripheral surface of the rack bar 130 and may have a curved surface or a flat surface.

The rack housing 160 may have an opening a position corresponding to or facing the rack support groove 134, and the housing cover 154 is coupled to the opening of the rack housing 160.

A cover support groove 156, in which the support member 151 is positioned, may be formed on the inner peripheral surface of the housing cover 154.

The rack support groove 134 may have, for example, but not limited to, a trapezoidal shape with a width that increases toward the housing cover 154.

The support member 151 may have a trapezoidal shape with a width that decreases from the cover support groove 156 toward the rack support groove 134.

Two opposite side surfaces of the rack support groove 134 may be closely contacted with and supported by the support member 151, and an inner surface of the rack support groove 134 positioned between the two opposite side surfaces of the rack support groove 134 may be spaced apart from the end of the support member 151.

A coating layer may be provided on the rack support groove 134 or the support member 151 and made of a low-friction material, such as fluorine resin or ceramic, in order to reduce or minimize friction.

The rack support groove 134 may be provided or filled with grease in order to reduce or minimize friction with the support member 151.

The housing cover 154 may be fixed to the rack housing 160 by the fastener 159.

The seal or sealing member 158 may be applied onto the end portion of the housing cover 154 and the outer peripheral surface of the rack housing 160 in order to prevent moisture or dust from being introduced from the outside of the rack housing 160.

The support member 151 and the housing cover 154 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

As described above, a steer-by-wire steering apparatus according to some embodiments of the present disclosure may have the plurality of motors and provide a steering force to a rack bar. In addition, a steer-by-wire steering apparatus according to some embodiments of the present disclosure may prevent unnecessary rotation of a rack bar even though means for preventing the rotation of the rack bar is provided and the pinion is excluded.

Hereinafter, various embodiments related to a method of determining the position of a rack bar in a steer-by-wire steering apparatus will be described. Some embodiments of the method of determining the position of the rack bar described below may be applied regardless of the above-mentioned configuration, position and shape of the motor. However, certain embodiments of the method of determining the position of the rack bar may be applied to the above-mentioned configuration, position and shape of the motor. In addition, the method of determining the position of the rack bar may be applied in exemplary embodiments of the steer-by-wire steering apparatus not including the rotation prevention member or may be applied in any type of a rotation prevention member.

In the steer-by-wire steering apparatus, the electronic control device 110 may control the operations of one or more drive motors (e.g., 145 and 147). For instance, the electronic control device 110 may receive information or one or more signals from one or more sensors associated with the vehicle and control one or more drive motors based on the information or signals received from one or more sensors.

One or more sensors include various sensors, such as a steering angle sensor, a steering torque sensor, a vehicle speed sensor, a rack position sensor, and any type of a sensor mounted to or provided in the vehicle in association with the steering of the vehicle. However, as described above, according to some embodiments of the present disclosure, the pinion may not be included in the steer-by-wire steering apparatus in case that the rack bar is configured to be moved by the first motor and the second motor. In this case, the rack position sensor configured to detect an absolute position of the rack bar may not be included in the steer-by-wire steering apparatus. Alternatively, the rack position sensor configured to detect the absolute position of the rack bar may be included in a gearbox configured to connect the first and/or second motors to the rack bar.

First, various embodiments for identifying the absolute position (or an absolute angle) of the rack bar will be described. Thereafter, an embodiment comprising an absolute angle sensor configured to detect the absolute position (or an absolute angle) of the rack bar will be described.

The electronic control device 110 may control an operation of the steering shaft motor 120. The electronic control device 110 may be configured as one chip integrated physically. Alternatively, the electronic control device 110 may be configured by a plurality of chips. For instance, each of a reaction force motor, a drive motor, a main control unit, and any component of the steer-by-wire steering apparatus includes one or more chips to perform their necessary operations.

Meanwhile, the electronic control device 110 may control a traveling direction of the vehicle in accordance with the driver's steering intention by controlling the operations of the plurality of drive motors (e.g., 145 and 147).

Multiple electronic control devices 110 may be provided in the steer-by-wire steering apparatus in order to ensure redundancy and constantly or stably perform the same operation even in a case that any one of the plurality of the electronic control devices 110 is abnormal or inoperable. Alternatively, the multiple electronic control devices 110 includes a main electronic control device and a sub-electronic control device. The main electronic control device may control the operation of the steer-by-wire steering apparatus if the main electronic control device is in a normal state, and the sub-electronic control device may control the operation of the steer-by-wire steering apparatus if the main electronic control device is abnormal or inoperable.

The electronic control device 110 may control the steering of the vehicle in response to various information. The steer-by-wire (SBW) system may need accurate information regarding a position of the rack bar to accurately control the steering of the vehicle especially in case that the plurality of motors is used to control the rack bar.

To this end, the electronic control device 110 may receive the position information of the rack bar from the rack position sensor. Alternatively, the electronic control device 110 may estimate the position of the rack bar by using positions of the plurality of motors without the rack position sensor.

For example, the electronic control device 110 may receive rotation information of each of the motors from the plurality of motor position sensors. In an exemplary embodiment of the present disclosure, the rotation information of the motor may include rotation information of the first motor and rotation information of the second motor. The rotation information of the first motor may be received from a first motor position sensor included in or associated with the first motor. The rotation information of the second motor may be received from a second motor position sensor included in or associated with the second motor.

The motor position sensor may detect rotation information of each of the motors. The motor position sensor may detect a rotation of a motor shaft. Alternatively, the motor position sensor may detect a rotation of any rotatable component or structure connected to or associated with the motor shaft. The motor position sensor may detect a rotary position between 0 degree and 360 degrees related to the rotation of the motor. For instance, the motor position sensor may measure a rotation angle and/or a position of the motor.

For example, the motor position sensor may be an optical sensor or encoder configured to detect a position by emitting light to a rotary plate or disk. Alternatively, the motor position sensor may be a magnetic sensor or encoder configured to measure a position of a rotor by detecting a magnetic field. Alternatively, the motor position sensor may be an incremental sensor or encoder configured to measure a change in a relative position of a rotor by outputting a predetermined pulse. Alternatively, the motor position sensor may be an absolute sensor or encoder configured to measure an absolute position of a rotor by outputting a unique value related to a particular position. The motor position sensor according to certain embodiments of the present disclosure may provide a precise position and/or velocity of the motor.

For instance, a Hall sensor, which measures a position of a motor by detecting a change in magnetic flux of a rotor to which a permanent magnet or magnetic material is attached or mounted, may be used as the motor position sensor. The motor of the steer-by-wire steering apparatus may be a Brushless Direct Current (BLDC) motor, and three Hall sensors having a phase difference of 120 degrees or 60 degrees may be arranged or disposed to detect the position of the motor. In addition, the motor position sensor may be a resolver configured to measure a position in an analog manner by using a change in voltage or an inductive position sensor configured to detect a position by using an electromagnetic induction principle. In the present disclosure, any type of sensors may be used as the motor position sensor.

The motor position sensor may measure an absolute position or an absolute angle value based on a particular position of the motor. Alternatively, the motor position sensor may detect a relative position with respect to a reference position. Alternatively, the motor position sensor may measure an electrical position of a rotor in a BLDC or Permanent Magnet Synchronous Motor (PMSM) motor.

A rotation angle in a single turn is a rotation angle between 0 degree and 360 degrees, and therefore a rotation angle can be represented in a single rotation turn only. Therefore, the absolute position of the motor which is over 360 degrees may not be identified because an angle of the rotor of the motor is reset after one full rotation turn. However, there is an absolute motor position sensor which can measure a position of the motor in multiple turns, but it has a complicated configuration and structure and a higher price.

Without using an absolute motor position sensor, some embodiments of the present disclosure may acquire an absolute position of the rack bar by using at least two motor position sensors which measure a relative position.

For example, when two motors move a same rack bar and have different rotational velocities, rotation angles measured by two motor position sensors of two motors, respectively, may be between 0 degree and 360 degrees. If the motor position sensor is not an absolute angle sensor, an angle measured by the motor position sensor is not recorded or stored, and a rotation angle detected by a motor position sensor of the first motor may be between 0 degree and 360 degrees and a rotation angle detected by a motor position sensor of the second motor may be between 0 degree and 360 degrees.

The electronic control device 110 may receive the rotation angle detected by the motor position sensor of the first motor and the rotation angle detected by the motor position sensor of the second motor. The electronic control device 110 estimates the absolute position of the rack bar by using two rotation angles (i.e., motor positions) detected by each of two motor positions sensors of two motors.

As described above, in certain embodiments of the present disclosure, the first motor and the second motor are operably connected to a single ball nut operably coupled to the rack bar and move the rack bar at different rotational velocities. Therefore, even though the first motor and the second motor rotate at different rotational velocities, the first motor and the second motor need to rotate the ball nut at the same velocity. Therefore, the motor pulley of the first motor and the motor pulley of the second motor may be configured by different in gear ratio.

The gear ratio may refer to, for example, but not limited to, a ratio of the numbers of threads or diameters of pulleys. For instance, the gear ratio may be a ratio between the number of threads or a diameter of a motor pulley connected to a motor shaft of the first motor and the number of threads or a diameter of a motor pulley connected to a motor shaft of the second motor. There may be a substantial difference in gear ratio in case that the diameters of the motor pulleys are different.

The first motor and the second motor may rotate at different rotational velocities, and the electronic control device 110 may receive different motor rotation information from the motor position sensors of the first and second motors.

The electronic control device 110 may determine the absolute position of the rack bar by using preset information and motor rotation information of the first and second motors.

For example, a difference in rotational velocity between the two motors may vary depending on the absolute position of the rack bar.

For example, the electronic control device 110 may determine the absolute position of the rack bar by monitoring a change in the rotation information of the two motors. For example, the electronic control device 110 may determine the position of the rack bar by using Equation 1.

$$R = \frac{K}{360} \times θ + K \times n \qquad [ Equation 1 ]$$

R represents a linear position of the rack bar, θ represents a phase difference between first rotation information of the first motor and second rotation information of the second motor, K represents a distance by which the rack bar is moved while a phase difference between the first rotation information and the second rotation information changes from 0 and a next phase difference becomes 0 in case that the rack bar moves in one direction, and n represents the number of times the phase difference becomes 0 while the rack bar moves in one direction.

That is, the electronic control device 110 may cumulatively identify the position of the rack bar by consistently monitoring the phase difference between the first rotation information of the first motor and the second rotation information of the second motor and recording the number of times the phase difference becomes 0.

In another example, the electronic control device 110 may determine the position of the rack bar based on a preset reference value. A movable range of the rack bar is structurally limited. Therefore, the plurality of positions of the rack bar corresponding to the first rotation information of the first motor and the second rotation information of the second motor can be calculated in advance and stored in the form of a table or other data formats in memory of the electronic control device 110.

When the first rotation information of the first motor and the second rotation information of the second motor are received, the electronic control device 110 may estimate the absolute position of the rack bar by comparing the first rotation information of the first motor and the second rotation information of the second motor with pre-stored data. However, in this case, the first rotation information and the second rotation information need to be designed to have different values in a linearly movable range of the rack bar. Therefore, a difference in gear ratio between the first motor and the second motor needs to be set so that the first rotation information of the first motor and the second rotation information of the second motor do not overlap at or correspond to two or more absolute positions of the rack bar.

For example, the electronic control device 110 may estimate the absolute position of the rack bar by using Equation 2.

$$A = \{ ( First Rotation Information + m ) \times First Gear Ratio \} \\ B = \{ ( Second Rotation Information + m ) \times Second Gear Ratio \} \\ Rack bar position R = intersection of A and B . \qquad [ Equation 2 ]$$

Here, m is a natural number equal to or larger than 1 and equal to or smaller than a maximum movable distance of the rack bar.

FIG. 17 is a graph for explaining a method of estimating a position of a rack bar using a difference between first rotation information of a first motor and second rotation information of a second motor. FIG. 17 illustrates relationship between the first rotation information of the first motor and the second rotation information of the second motor and a linear position of a rack bar in a movable range of the rack bar from 0 to 75 mm. As described above, the first gear ratio and the second gear ratio may be set so that the first rotation information of the first motor and the second rotation information of the second motor do not overlap or correspond to multiple positions of the rack bar.

FIGS. 18 to 21 show a part of a vehicle steering apparatus according to an embodiment of the present disclosure.

The support surface 130-1 is provided on the outer peripheral surface of the rack bar 130 having a rod shape. For example, the support surface 130-1 is substantially flat. The support surface 130-1 may be formed by machining the outer peripheral surface of the rack bar 130 in the axial direction of the rack bar 130.

The anti-rotation member 150 (e.g. an anti-rotation support) is coupled to and supported on the outer peripheral surface of the rack bar 130 and the inner peripheral surface of the rack housing 160 and supports the rack bar 130, thereby preventing the rotation of the rack bar 130.

That is, the support surface 130-1 is provided at one side of the outer peripheral surface of the rack bar 130, and the anti-rotation member 150 supports the support surface 130-1, thereby preventing the rotation of the rack bar 130 caused by the rotational torque of the ball nut 141.

In addition, the support surface 130-1 is elongated in the axial direction of the rack bar 130. When the rack bar 130 is slid by the rotation of the ball nut 141, the rack bar 130 slides in the axial direction while the support surface 130-1 is supported by the anti-rotation member 150.

Therefore, when the rack bar 130 slides, the rack bar 130 is guided by the anti-rotation member 150, and a predetermined load is applied such that the rack bar 130 may stably slide without vibration or noise and an accurate movement amount may be maintained.

The anti-rotation member 150 may include a cylinder portion 251 having an inner peripheral surface configured to support the outer peripheral surface of the rack bar 130, and an outer peripheral surface coupled to and supported by the inner peripheral surface of the rack housing 160, and an inner peripheral support portion 255 extending from the inner peripheral surface of the cylinder portion 251, formed as a flat surface facing the support surface 130-1, and supporting the support surface 130-1.

In this case, the anti-rotation member 150 may be required to have predetermined rigidity and elasticity and made of one or more materials selected from a group consisting of, for example, but not limited to, polyacetal (POM), polyamide (PA), polycarbonate (PC), polyimide (PI), polybutylene terephthalate (PBT), polyphenylene sulfide (PPS), and phenol formaldehyde (PF).

The inner peripheral support portion 255 extends or protrudes radially inward from the inner peripheral surface of the cylinder portion 251, and the inner peripheral support portion 255 is provided with one or more inner peripheral grooves 255a formed on the inner peripheral surface of the cylinder portion 251, which supports the support surface 130-1 of the rack bar 130, and elongated in the axial direction.

This configuration may reduce sliding resistance, which occurs while the rack bar 130 slides in the axial direction, and absorb an inadvertent movement that occurs at a predetermined angle with respect to the sliding direction of the rack bar 130.

The cylinder portion 251 may be provided with a one-end cut-out portion 251a. For instance, the one-end cut-out portion 251a may be formed by cutting one end of the cylinder portion 251 in the axial direction so that one end of the cylinder portion 251 is open. Multiple portions of one end of the cylinder portion 251 may be cut to form the one-end cut-out portion 251a.

The one-end cut-out portion 251a is formed by cutting the inner peripheral surface and the outer peripheral surface of the cylinder portion 251 in the axial direction from one end of the cylinder portion 251 to a position spaced apart from the other end of the cylinder portion 251.

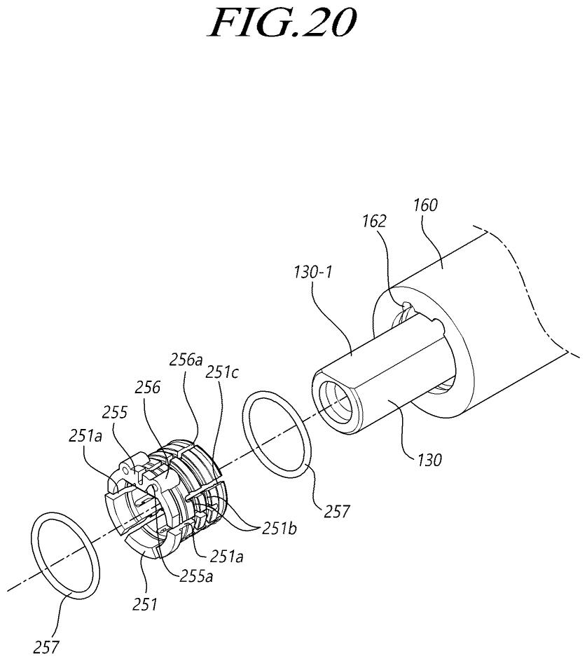

The one-end cut-out portion 251a may be provided as the plurality of one-end cut-out portions 251a spaced apart from one another in the circumferential direction of the cylinder portion 251. FIGS. 20 and 21 illustrate an example in which four one-end cut-out portions 251a are provided at predetermined intervals in the circumferential direction.

Further, the cylinder portion 251 may be provided with the other-end cut-out portion 251c. For example, the other-end cut-out portion 251c may be formed by cutting the other end of the cylinder portion 251 in the axial direction so that the other end of the cylinder portion 251 is open. Multiple portions of the other end of the cylinder portion 251 may be cut to form the other-end cut-out portion 251c. The other-end cut-out portion 251c is formed by cutting the inner peripheral surface and the outer peripheral surface of the cylinder portion 251 in the axial direction from the other end of the cylinder portion 251 to a position spaced apart from one end of the cylinder portion 251.

The other-end cut-out portion 251c may be provided as the plurality of other-end cut-out portions 251c spaced apart from one another in the circumferential direction of the cylinder portion 251. The other-end cut-out portions 251c and the one-end cut-out portions 251a may be disposed alternately.

This configuration may reduce sliding resistance, which occurs while the rack bar 130 slides in the axial direction, and absorb an inadvertent movement that occurs at a predetermined angle with respect to the sliding direction.

In addition, the cylinder portion 251 may be provided with a shaft hole 256a configured to communicate with the other-end cut-out portion 251c in the axial direction. The shaft hole 256a is recessed from the outer surface of the inner peripheral support portion 255 in a radial direction, but the shaft hole 256a may not penetrate all the way through the inner peripheral support portion 255 and the innermost end of the shaft hole 256a may be spaced apart from the inner peripheral surface of the inner peripheral support portion 255.

That is, the shaft hole 256a is formed from one end to the other end of the cylinder portion 251 in the axial direction, but the shaft hole 256a may not penetrate all the way through the inner peripheral support portion 255 and the innermost end of the shaft hole 256a may be spaced apart from the inner peripheral surface of the inner peripheral support portion 255 at one end of the cylinder portion 251.

This configuration may facilitate elastic deformation of the inner peripheral support portion 255, which is relatively thicker than the cylinder portion 251, and maintain a fixing force between the rack housing 160 and fixing protrusions 256 to be described below.

The anti-rotation member 150 may further include elastic members 257 coupled to the outer peripheral surface of the cylinder portion 251 and elastically supporting the inner peripheral surface of the rack housing 160.

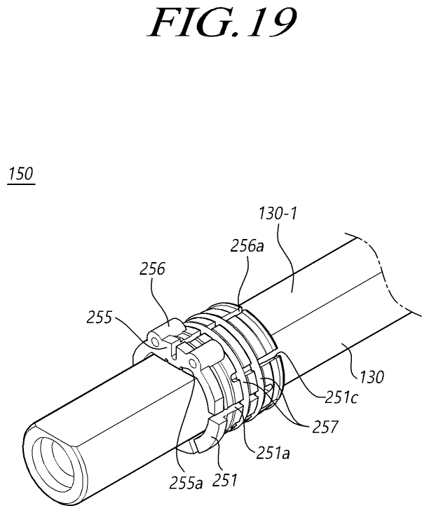

The elastic member 257 may have a ring shape, and be coupled to the outer peripheral surface of the cylinder portion 251. The elastic members 256 may be spaced apart from each other in the axial direction. An example in which two elastic members 257 are coupled is illustrated in FIGS. 19-20.

The elastic member 257 may be made of one or more materials selected from a group consisting of, for instance, but not limited to, natural rubber (NR), nitrile butadiene rubber (NBR), chloroprene rubber (CR), ethylene propylene diene monomer (EPDM), fluoro-rubber (FPM), styrene butadiene rubber (SBR), chlorosulphonated polyethylene (CSM), urethane, and silicone so that the elastic member 257 has predetermined elasticity corrosion resistance.

Circumferential grooves 251b, to which the elastic members 257 are inserted or coupled, may be formed in the outer peripheral surface of the cylinder portion 251. The circumferential groove 251b may be formed at a position that overlaps the one-end cut-out portion 251a and the other-end cut-out portion 251c.

Because the elastic member 257 is located or coupled to a position where the elastic member 257 overlaps the one-end cut-out portion 251a and the other-end cut-out portion 251c as described above, it is possible to effectively absorb an inadvertent movement occurring at a predetermined angle with respect to the sliding direction of the rack bar 130 even though an impact load is inversely inputted to the rack bar 130 from a road surface.

In addition, the fixing protrusions 256 may be provided on an outer peripheral surface of the inner peripheral support portion 255 and protrude in the radial direction from the outer peripheral surface of the inner peripheral support portion 255. Fixing grooves 162, to which the fixing protrusions 256 are coupled, may be provided on the inner surface of the rack housing 160.

The fixing protrusion 256 of the anti-rotation member 150 is coupled to the fixing groove 162 formed on the inner surface of the rack housing 160 and supported by the rack housing 160, such that the anti-rotation member 150 and the rack bar 130 may be supported by the rack housing 160 without rotating even though an impact load is inversely inputted to the rack bar 130 from the road surface.

FIGS. 22 to 24 show a part of a vehicle steering apparatus according to another embodiment of the present disclosure.

The rack bar 130 having a rod shape may be provided with a support groove 130-2 recessed to a predetermined depth from the outer peripheral surface of the rack bar 130 and elongated in the axial direction of the rack bar 130.

The anti-rotation member 150 may be coupled to the support groove 130-2 of the rack bar 130 to prevent the rotation of the rack bar 130.

The anti-rotation member 150 may include the cylinder portion 251 having the inner peripheral surface configured to support the outer peripheral surface of the rack bar 130 and the outer peripheral surface coupled to and supported by the inner peripheral surface of the rack housing 160, and an inner peripheral protruding portion 259 protruding from the inner peripheral surface of the cylinder portion 251 toward the support groove 130-2 and inserted into and supported on the support groove 130-2 of the rack bar 130.

The support groove 130-2 is formed to have a circumferential width that decrease from an outer peripheral surface toward a bottom surface of the support groove 130-2 formed as a flat surface. The inner peripheral protruding portion 259 corresponds to the support groove 130-2 and is formed to have a circumferential width that decreases as the inner peripheral protruding portion 259 protrudes toward the support groove 130-2.

The cylinder portion 251 may be provided with the one-end cut-out portion 251a. For instance, the one-end cut-out portion 251a may be formed by cutting one end of the cylinder portion 251 in the axial direction so that one end of the cylinder portion 251 is open. Multiple portions of one end of the cylinder portion 251 may be cut to form the one-end cut-out portion 251a. The one-end cut-out portion 251a may be formed by cutting the inner peripheral surface and the outer peripheral surface of the cylinder portion 251 in the axial direction from one end of the cylinder portion 251 to the position spaced apart from the other end of the cylinder portion 251 at a predetermined distance.

The one-end cut-out portion 251a may be provided as the plurality of one-end cut-out portions 251a spaced apart from one another in the circumferential direction of the cylinder portion 251. An example in which four one-end cut-out portions 251a are provided at predetermined intervals in the circumferential direction is illustrated in FIGS. 22-24.

In addition, the cylinder portion 251 may be provided with the other-end cut-out portion 251c. For example, the other-end cut-out portion 251c may be formed by cutting the other end of the cylinder portion 251 in the axial direction so that the other end of the cylinder portion 251 is open. Multiple portions of the other end of the cylinder portion 251 may be cut to form the other-end cut-out portion 251c.

The other-end cut-out portion 251c may be formed by cutting the inner peripheral surface and the outer peripheral surface of the cylinder portion 251 in the axial direction from the other end of the cylinder portion 251 to the position spaced apart from one end of the cylinder portion 251 at a predetermined distance.

The other-end cut-out portion 251c may be provided as plurality of other-end cut-out portions 251c spaced apart from one another in the circumferential direction of the cylinder portion 251. The other-end cut-out portions 251c and the one-end cut-out portions 251a may be disposed alternately in the circumferential direction.

Because the plurality of one-end cut-out portions 251a and the plurality of other-end cut-out portions 251c are disposed alternately in the circumferential direction as described above, it is possible to reduce sliding resistance, which occurs while the rack bar 130 slides in the axial direction, and absorb an inadvertent movement that occurs at a predetermined angle with respect to the sliding direction.

Further, the cylinder portion 251 may be provided with a shaft hole 256a configured to communicate with the other-end cut-out portion 251c in the axial direction. The shaft hole 256a is recessed from the outer surface of the cylinder portion 251 in a radial direction, but the shaft hole 256a may not penetrate all the way through the cylinder portion 251 and the innermost end of the shaft hole 256a may be spaced apart from the inner peripheral surface of the inner peripheral protruding portion 259.

The shaft hole 256a is formed from one end to the other end of the cylinder portion 251 in the axial direction, but the shaft hole 256a may not penetrate all the way through the cylinder portion 251 and the innermost end of the shaft hole 256a may be spaced apart from the inner peripheral surface of the inner peripheral protruding portion 259 at one end of the cylinder portion 251.

This configuration may facilitate elastic deformation of the inner peripheral protruding portion 259, which is thicker than the cylinder portion 251, and maintain a fixing force between the fixing protrusion 256 and the rack housing 160.

The anti-rotation member 150 may further include the elastic members 257 coupled to the outer peripheral surface of the cylinder portion 251 and elastically supporting the inner peripheral surface of the rack housing 160. The elastic member 257 according to the present embodiment may be identical or similar to the elastic member 257 according to the embodiment illustrated in FIGS. 19 and 20 described above.

Because the elastic member 257 is located or coupled to a position where the elastic member 257 overlaps the one-end cut-out portion 251a and the other-end cut-out portion 251c as illustrated in FIG. 22. Therefore, it is possible to effectively absorb an inadvertent movement occurring at a predetermined angle with respect to the sliding direction of the rack bar 130 even though an impact load is inversely inputted from the road surface.

Further, the fixing protrusion 256 may be formed on the outer peripheral surface of the inner peripheral protruding portion 259, and the support groove 162 of the rack housing 160 according to the present embodiment may be identical or similar to the support groove 162 of the rack housing 160 illustrated in FIG. 21 described above.

FIGS. 25 and 26 show a part of a vehicle steering apparatus according to still another embodiment of the present disclosure.

Two or more support surfaces 130-1 may be provided on the rack bar 130. For instance, as illustrated in FIGS. 25 and 26, the support surfaces 130-1 are respectively provided at positions that face each other in the radial direction of the rack bar 130.

Further, the anti-rotation member 150 may be coupled to and support either one or both of the support surfaces 130-1 to prevent the rotation of the rack bar 130.

The anti-rotation member 150 may include rotatable parts 191 supporting the support surfaces 130-1 of the rack bar 130 and configured to be rotatable when the rack bar 130 slides in the axial direction, and rotation support members 190 to which the rotatable parts 191 are rotatably coupled.

For example, the rotatable parts 191 may comprise a roller or a needle bearing coupled to the rotation support member 190 and configured to be rotatable. In some instances, the rotatable parts 191 may include a square bearing.

Further, coupling grooves 164 may be provided in the inner peripheral surface of the rack housing 160, and the anti-rotation member 150 may be coupled to and supported by the coupling grooves 164 of the rack housing 160.

The coupling grooves 164 may be formed in the inner peripheral surface of the rack housing 160 and face the support surface 130-1 of the rack bar 130, and one end of the coupling grooves 164 may open at one end of the rack housing 160.

Therefore, the anti-rotation member 150 may be inserted by sliding from one end of the rack housing 160 when the anti-rotation member 150 is assembled to the rack bar 130 and the rack housing 160, thereby facilitating the assembling process of the rotatable parts.

As described above, some embodiments of the present disclosure may prevent the rotation of a rack bar caused by rotational torque of a ball nut, thereby enhancing steering stability and allowing the driver's steering intention to be effectively and accurately transmitted to the rack bar.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded the widest scope consistent with the claims.

What is claimed is:

1. A vehicle steering apparatus comprising:
a ball nut rotatably coupled to a rack bar and configured to linearly move the rack bar by rotation of the ball nut;
first and second nut pulleys provided on an outer surface of the ball nut;
a first motor pulley of a first motor operably connected to the first nut pulley of the ball nut through a first belt;
a second motor pulley of a second motor operably connected to the second nut pulley of the ball nut through a second belt; and
an anti-rotation support supporting an outer surface of the rack bar and coupled to an inner surface of a rack housing, and configured to prevent rotation of the rack bar.

2. The vehicle steering apparatus of claim 1, wherein the rack bar has a flat support surface on the outer surface of the rack bar, and the anti-rotation support supports the flat support surface of the rack bar.

3. The vehicle steering apparatus of claim 2, wherein the anti-rotation support comprises:
a cylinder portion having an inner surface supporting the outer surface of the rack bar, and an outer surface coupled to the inner surface of the rack housing; and
an inner peripheral support portion extending from the inner surface of the cylinder portion and having a flat surface facing the flat support surface of the rack bar.

4. The vehicle steering apparatus of claim 3, wherein the cylinder portion of the anti-rotation support has one or more first cut-out portions at one end of the cylinder portion.

5. The vehicle steering apparatus of claim 4, wherein the one or more first cut-out portions of the cylinder portion of the anti-rotation support include a plurality of first cut-out portions spaced apart from one another at the one end of the cylinder portion.

6. The vehicle steering apparatus of claim 5, wherein the cylinder portion of the anti-rotation support has one or more second cut-out portions at another end of the cylinder portion.

7. The vehicle steering apparatus of claim 6, wherein the one or more second cut-out portions of the cylinder portion of the anti-rotation support include a plurality of second cut-out portions spaced apart from one another at the another end of the cylinder portion, and the plurality of first cut-out portions at the one end of the cylinder portion and the plurality of second cut-out portions at the another end of the cylinder portion are disposed alternately.

8. The vehicle steering apparatus of claim 3, wherein the anti-rotation support further comprises an elastic material coupled to the outer surface of the cylinder portion and elastically supporting the inner surface of the rack housing.

9. The vehicle steering apparatus of claim 3, wherein a fixing protrusion protrudes from an outer surface of the inner peripheral support portion of the anti-rotation support, and is coupled to a fixing groove formed on the inner surface of the rack housing.

10. The vehicle steering apparatus of claim 1, wherein the rack bar has a support groove recessed from the outer surface of the rack bar and elongated in an axial direction of the rack bar, and a part of the anti-rotation support is disposed in the support groove of the rack bar.

11. The vehicle steering apparatus of claim 10, wherein the anti-rotation support comprises:
a cylinder portion having an inner surface supporting the outer surface of the rack bar, and an outer surface coupled to the inner surface of the rack housing; and
an inner peripheral protruding portion protruding from the inner surface of the cylinder portion and inserted in the support groove of the rack bar.

12. The vehicle steering apparatus of claim 11, wherein the cylinder portion of the anti-rotation support has one or more first cut-out portions at one end of the cylinder portion.

13. The vehicle steering apparatus of claim 12, wherein the one or more first cut-out portions of the cylinder portion of the anti-rotation support include a plurality of first cut-out portions spaced apart from one another at the one end of the cylinder portion.

14. The vehicle steering apparatus of claim 13, wherein the cylinder portion of the anti-rotation support has one or more second cut-out portions at another end of the cylinder portion.

15. The vehicle steering apparatus of claim 14, wherein the one or more second cut-out portions of the cylinder portion of the anti-rotation support include a plurality of second cut-out portions spaced apart from one another at the another end of the cylinder portion, and the plurality of first cut-out portions at the one end of the cylinder portion and the plurality of second cut-out portions at the another end of the cylinder portion are disposed alternately.

16. The vehicle steering apparatus of claim 15, wherein the anti-rotation support further comprises an elastic material coupled to the outer surface of the cylinder portion and elastically supporting the inner surface of the rack housing.

17. The vehicle steering apparatus of claim 2, wherein the rack bar has another flat support surface, the flat support surface and the another flat support surface of the rack bar are positioned on opposite sides of the rack bar, respectively, and the anti-rotation support supports the flat support surface and the another flat support surface of the rack bar.

18. The vehicle steering apparatus of claim 17, wherein the anti-rotation support comprises:
a ratable part supporting the flat support surface of the rack bar and configured to be rotatable when the rack bar linearly moves; and
a rotation support portion to which the rotatable part of the anti-rotation support is rotatably coupled.

19. The vehicle steering apparatus of claim 18, wherein the rack housing has a coupling groove on the inner surface of the rack housing, and a part of the anti-rotation support is disposed in the coupling groove of the rack housing.

20. A vehicle comprising:
a ball nut rotatably coupled to a rack bar and configured to linearly move the rack bar by rotation of the ball nut;
first and second nut pulleys provided on an outer surface of the ball nut;
a first motor pulley of a first motor operably connected to the first nut pulley of the ball nut through a first belt;
a second motor pulley of a second motor operably connected to the second nut pulley of the ball nut through a second belt;
an anti-rotation support supporting an outer surface of the rack bar and coupled to an inner surface of a rack housing, and configured to prevent rotation of the rack bar;
a first motor sensor configured to detect a position of the first motor;
a second motor sensor configured to detect a position of the second motor; and
a controller configured to control the first motor and the second motor.
